(19) United States
(12) Patent Application Publication
(10) Pub. No.: US 2025/0291419 A1
(43) Pub. Date: Sep. 18, 2025

(54) METHODS FOR PARSING SCENE DESCRIPTION DOCUMENT

(71) Applicant: Hisense Visual Technology Co., Ltd., Shandong (CN)

(72) Inventors: Fuzheng YANG, Shandong (CN); Wei ZHANG, Shandong (CN); Yimo CAO, Shandong (CN); Hejie YANG, Shandong (CN); Junjie WANG, Shandong (CN); Zhikui WANG, Shandong (CN); Bin LI, Shandong (CN); Fang XING, Shandong (CN)

(73) Assignee: Hisense Visual Technology Co., Ltd., Shandong (CN)

(21) Appl. No.: 19/223,069

(22) Filed: May 30, 2025

Related U.S. Application Data
(63) Continuation of application No. PCT/CN2024/070187, filed on Jan. 2, 2024.

(30) Foreign Application Priority Data
Jan. 10, 2023 (CN) 202310036790.8
Mar. 20, 2023 (CN) 202310275300.X
Apr. 6, 2023 (CN) 202310362214.2
Apr. 11, 2023 (CN) 202310383151.9
Sep. 22, 2023 (CN) 202311236289.2

(51) Int. Cl. G06F 3/01; G06T 13/20; G06T 15/04; G06T 17/20

(52) U.S. Cl. CPC G06F 3/016; G06T 13/20; G06T 15/04; G06T 17/20; G06T 2210/61

(57) ABSTRACT

A method for parsing a scene description document, including: determining an index value of a target haptic object description module; obtaining the target haptic object description module from a moving picture experts group (MPEG) haptic description module in the scene description document according to the index value of the target haptic object description module; and obtaining description information of a haptic media accessor according to the target haptic object description module, where the haptic media accessor is an accessor configured to access haptic rendering data of a haptic media file declared in an MPEG media description module.

### CROSS REFERENCE TO RELATED APPLICATIONS

This application is a continuation application of PCT patent application No. PCT/CN2024/070187, filed on Jan. 2, 2024, which claims priority to Chinese Patent Application No. 202310036790.8 filed on Jan. 10, 2023, Chinese Patent Application No. 202310383151.9 filed on Apr. 11, 2023, Chinese Patent Application No. 202310362214.2 filed on Apr. 6, 2023, Chinese Patent Application No. 202311236289.2 filed on Sep. 22, 2023, and Chinese Patent Application No. CN202310275300.X, filed on Mar. 20, 2023, the entire contents of the above-identified applications are incorporated herein by reference.

### FIELD

Some embodiments of the present disclosure relate to the technical field of video processing, and in particular, to a method for parsing a scene description document.

### BACKGROUND

With the increasing richness of three-dimensional (3D) media content, users have higher requirements for a sense of reality and richness of a virtual scene. As a part of sensory experience, a haptic sense becomes object experience that needs to be considered and added in immersive media. For example, users may experience an explosion effect in the virtual scene, which not only requires participation of visual and auditory senses, but also requires participation of the haptic sense as a type of sensory experience, so as to enhance a sense of reality and a sense of presence that are brought by the explosion effect in the virtual scene to people.

In relevant technical standards, each haptic material attribute is represented by a texture array, and texture arrays of different attributes are combined to form a specific haptic perception. Each array element includes a haptic texture and an enumerated type of the haptic material attribute, and the type of the haptic material attribute includes High_resolution, Low_resolution, Reference, and Other. When the type of the haptic material attribute is the High_resolution or the Low_resolution, a texture map or a haptic texture material data packet that is indexed by a texture stores haptic values instead of color values. These haptic values may be directly obtained and haptically rendered by a display engine. When the type of the haptic material attribute is the Reference, each pixel in the texture map or the haptic texture material data packet does not directly store the haptic value, but stores an index value of a to-be-rendered haptic media file. As described above, when the type of the haptic material attribute is the Reference, data obtained from the texture map or the haptic texture material data packet is an index value of haptic media. Based on the index value, only an encoded and encapsulated haptic media file may be obtained, and a decoded haptic value that may be used for rendering cannot be obtained. As a result, the display engine cannot perform the rendering normally.

### SUMMARY

In accordance with a first aspect, some embodiments of the present disclosure provide a method for generating a scene description document, including: when a 3D-scene-to-be-rendered includes a haptic media file, determining a type of each haptic material attribute in the haptic media file; and when a type of a first haptic material attribute in the haptic media file is Reference, adding an accessor index syntax element to moving pictures experts group (MPEG) haptic of a target node description module in a scene description document of the 3D-scene-to-be-rendered, and setting a value of the accessor index syntax element to an index value of an accessor description module corresponding to a haptic media accessor, where the target node description module is a node description module corresponding to a node of a target 3D mesh carrying the first haptic material attribute, and the haptic media accessor is an accessor for accessing decoded data of the haptic media file method for parsing a scene description document, including: determining an index value of a target haptic object description module; obtaining the target haptic object description module from a moving picture experts group (MPEG) haptic description module in the scene description document according to the index value of the target haptic object description module; and obtaining description information of a haptic media accessor according to the target haptic object description module, where the haptic media accessor is an accessor configured to access haptic rendering data of a haptic media file declared in an MPEG media description module.

In accordance with a second aspect, some embodiments of the present disclosure provide an apparatus for parsing a scene description document, including: a memory configured to store a computer program; and a processor configured to invoke the computer program to enable the apparatus for parsing the scene description document to implement the method for parsing the scene description document in the first aspect.

In accordance with a third aspect, some embodiments of the present disclosure provide a non-transitory computer-readable storage medium, where the computer-readable storage medium stores a computer program, that, when executed by a computer device, causes the computer device to implement the method for parsing the scene description document in the first aspect.

In accordance with a fourth aspect, some embodiments of the present disclosure provide a computer program product, when the computer program product is operated on a computer, the computer is caused to implement the method for parsing the scene description document.

### BRIEF DESCRIPTION OF THE DRAWINGS

FIG. 1 is a schematic structural diagram of an immersive media description framework according to some embodiments of the present disclosure;

FIG. 2 schematically shows a data model of haptic data according to some embodiments of the present disclosure;

FIG. 3 schematically shows a hierarchical structure of a human body according to some embodiments of the present disclosure;

FIG. 4 is a schematic structural diagram of a haptic signal encoder according to some embodiments of the present disclosure;

FIG. 5 is a schematic structural diagram of a haptic signal decoder according to some embodiments of the present disclosure;

FIG. 6 is a schematic structural diagram of a scene description document according to some other embodiments of the present disclosure;

FIG. 7 is a schematic structural diagram of a scene description document according to some other embodiments of the present disclosure;

FIG. 8 is a flowchart of steps of a method for generating a scene description document according to some embodiments of the present disclosure;

FIG. 9 is a flowchart of steps of a method for parsing a scene description document according to some embodiments of the present disclosure;

### DETAILED DESCRIPTION OF EMBODIMENTS

To make the objectives and implementations of the present disclosure clearer, the following clearly and completely describes the exemplary implementations of the present disclosure with reference to the accompanying drawings in the exemplary embodiments of the present disclosure. Apparently, the described exemplary embodiments are some rather than all the embodiments of the present disclosure.

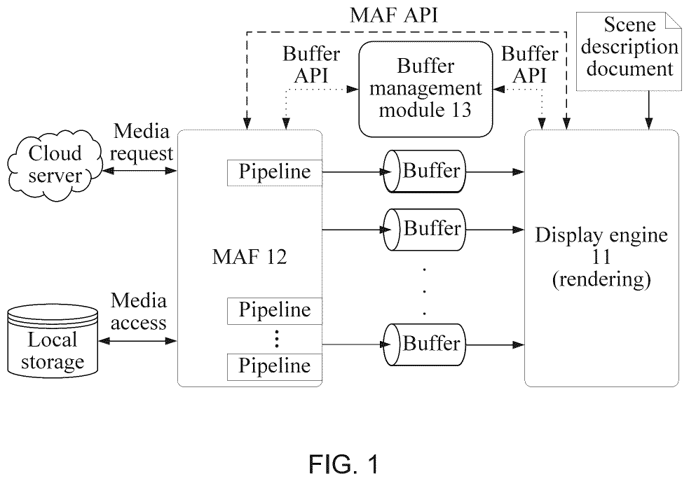

Some embodiments of the present disclosure relate to scene description of immersive media. Referring to a scene description framework for immersive media in FIG. 1, in order to enable a display engine 11 to focus on media rendering, the scene description framework for the immersive media decouples access and processing of a media file from rendering of the media file, and designs a media access function (MAF) 12 to access and process the media file. In addition, a MAF application programming interface (API) is designed, and instruction interaction is performed between the display engine 11 and the MAF 12 through the MAF API. The display engine 11 may issue an instruction to the MAF 12 through the MAF API, and the MAF 12 may also request an instruction from the display engine 11 through the MAF API.

A general working process of the scene description framework for the immersive media is as follows: 1) The display engine 11 obtains a scene description document provided by an immersive media service provider. 2) The display engine 11 parses the scene description document, obtains an access address of the media file, attribute information (such as a media type and a codec parameter) of the media file, a format requirement of a processed media file, and other parameters or information, and calls the MAF API to transfer all or part of the information obtained by parsing the scene description document to the MAF 12. 3) The MAF 12 requests to download the media file from a media resource server or obtains the media file locally based on the information transferred by the display engine 11, and establishes a corresponding pipeline for the media file. Then, processing such as decapsulation, decryption, and decoding is performed on the media file in the pipeline to convert the media file from an encapsulated format to a format specified by the display engine 11. 4) The pipeline stores data output after the processing in a specified buffer. 5) Finally, the display engine 11 reads the processed data from the specified buffer and renders the media file based on the data read from the buffer.

In addition, based on the ISOBMFF (ISO/IEC 14496-12), the ISO/IEC 23090-14 also defines a transmission format for delivering the scene description document and data related to a glTF 2.0 extension. In order to facilitate delivery of the scene description document to the client, the ISO/IEC 23090-14 defines how to encapsulate a glTF file and related data in the ISOBMFF file as non-time-varying data and time-varying data (for example, as a track sample). The MPEG_scene_dynamic, the MPEG_mesh_linking, and the MPEG_animation_timing provide the display engine with time-varying data in a specific form, and the display engine 11 should perform a corresponding operation based on the changing information. The ISO/IEC 23090-14 also defines a format for time-varying data of each extension and a method for encapsulating the time-varying data in the ISOBMFF file.

The MPEG media (MPEG_media) allows referencing an external media stream transmitted through protocols such as the RTP/Secure Real-time Transport Protocol (SRTP) and MPEG-DASH. In order to address a media stream without knowing an actual protocol scheme, a host name, or a port value, the ISO/IEC 23090-14 defines a new URL scheme. This scheme requires existence of a stream identifier in a query part, but does not specify a specific identifier type, allowing use of a media stream identification scheme (RFC5888), a labeling scheme (RFC4575), or a 0-based indexing scheme.

A haptic sense provides the user with additional entertainment and sensory immersion, and experience and enjoyment that media content brings to the user may be significantly enhanced by correctly adding the haptic sense to audio/video content. If there is a standardized and unified data model for representing haptic data, and the data model includes all information required for a designated synthesizer to present a haptic effect, the haptic data may be standardly decoded.

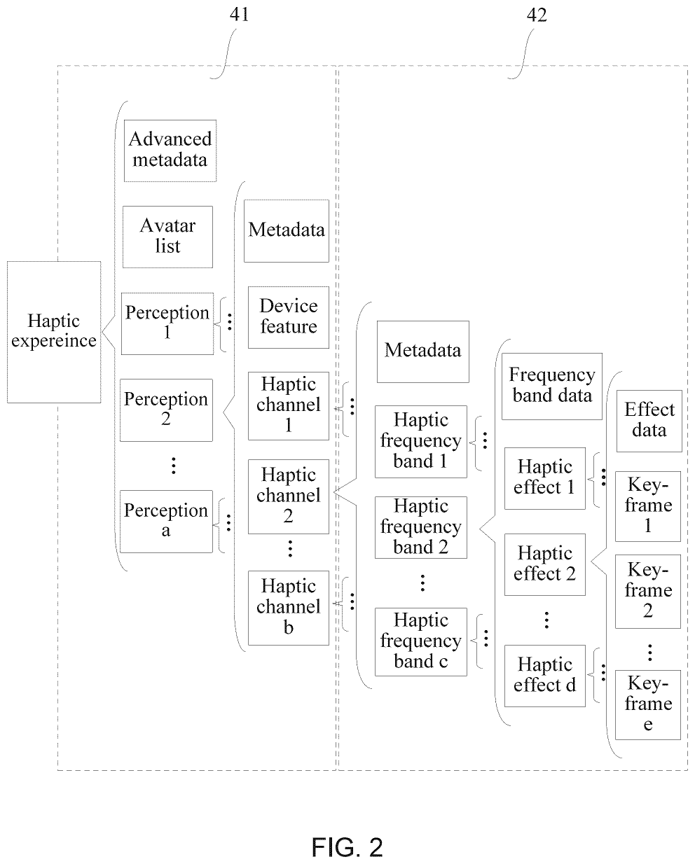

FIG. 2 is a schematic structural diagram of a haptic data model. As shown in FIG. 2, the haptic data model includes a description part 41 and an encoding part 42, and adopts a hierarchical structure to describe the haptic data layer by layer. The description part 41 focuses on perceptual and haptic channel information as main description content in a data structure, while the encoding part 42 focuses on a haptic frequency band, a haptic effect, and a keyframe as main description content in the data structure. A highest layer of the description part 41 includes an overall description of content included in the data structure, and is typically used to describe entire haptic experience defined in a file or a media stream. The haptic experience includes some advanced metadata and provides a pre-defined list of avatars (namely representations of body parts) for subsequently specifying a position at which a haptic stimulus is implemented on a body. The haptic data is described through a perception list (perceptions 1 to a). Each haptic perception in the perception list corresponds to a haptic signal related to a specific perception modality (such as vibration, force, position, speed, or temperature). Each perception in the perception list includes some features related to a haptic implementation device and metadata information associated with the perception, such as an avatar. A perceptual signal itself is generated by mixing a plurality of haptic channels (haptic channels 1 to b) together in addition to the metadata. Each haptic channel not only includes metadata on a channel configuration (such as a mixing gain), but also includes a haptic frequency band list (haptic frequency bands 1 to c) decomposed by frequency band. A partial signal within a frequency range is given for frequency band data of each haptic frequency band. The haptic frequency band is described using the frequency band data and a haptic effect list (haptic effects 1 to d). Each haptic effect in the haptic effect list includes a keyframe list (keyframes 1 to e). Different frequency bands include different signals, and a haptic signal in a channel may be reconstructed by combining data from different frequency bands.

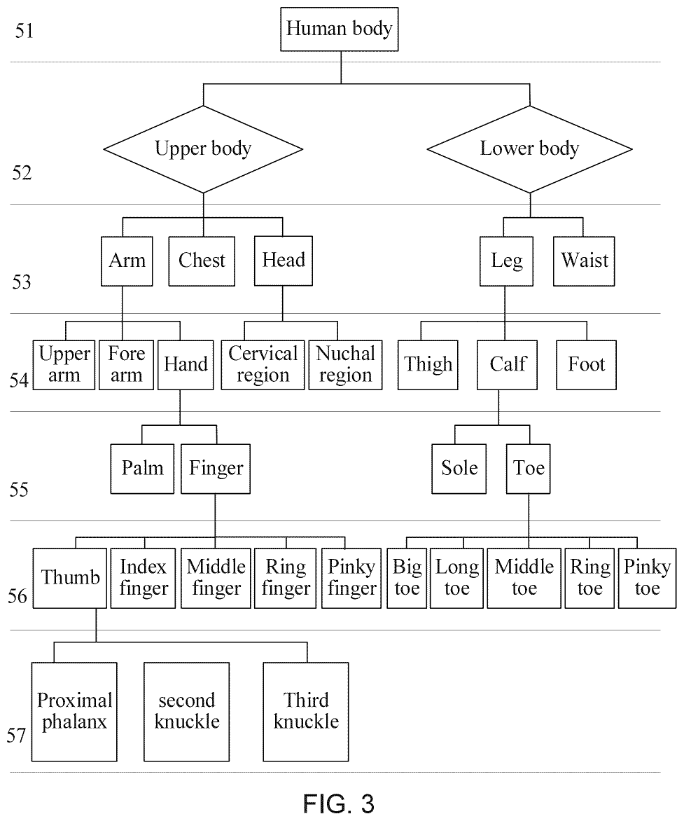

In some embodiments, in order to achieve a channel-level haptic effect in a designated body part, the hierarchical structure may also be used to describe a part of a human body layer by layer. As shown in FIG. 3, the human body hierarchically includes: a first hierarchy 51 including all parts of the human body; a second hierarchy 52 including an upper body and a lower body; a third hierarchy 53 including an arm, a chest, a head of the upper body, as well as a leg and a waist of the lower body; a fourth hierarchy 54 including an upper arm, a forearm hand, cervical and nuchal regions of the head, a thigh, a calf and a foot; a fifth hierarchy 55 including a palm, a finger, a sole, and a toe; a sixth hierarchy 56 including a thumb, an index finger, a middle finger, a ring finger, a pinky finger, a big toe, a long toe, a middle toe, a ring toe, and a pinky toe; and a seventh hierarchy 57 including a proximal phalanx, a second knuckle, and a third knuckle of the thumb.

All perception modalities of the haptic perception in the haptic data model are shown in following Table 1:

TABLE 1

| | | Unit of an |
|---|---|---|
| | Physical unit of | independent |
| Modality name | the haptic perception | variable |
| Pressure | Pa | S |
| Acceleration | m/s\hat{ }2 | S |
| Speed | m/s | S |
| Position | m | S |
| Temperature | K | S |
| Vibratory haptic sense | −1/1 (normalized) | S |
| Water | m\hat{ }3 | S |
| Wind | m/s | S |
| Force | N | S |
| Electric haptic sensation | −1/1 (normalized) | S |
| Vibration texture | −1/1 (normalized) | m |
| Stiffness | N | m |
| Friction | −1/1 (normalized) | m |
| Others | −1/1 (normalized) | S |

Digital encoding is crucial for allowing a digital haptic device to run. As a first-order media type similar to audio and video, a haptic media file also stores the haptic data in a digital format. At present, there is no unified encoding format for the haptic media file, and encoding formats developed and used by various technology manufacturers are different. As a result, the haptic media file is incompatible with a decoder-end format, hindering widespread application of the haptic sense in the market. Therefore, when developing an ISO/IEC 23090-31 haptic standard, Working Group 7 of the ISO/IEC MPEG highlights necessity of standardizing a haptic encoding representation. A standard haptic encoding format (and a related standardized decoder) will help incorporate the haptic sense into ISOBMFF, MPEG-DASH, and MPEG-I standards, making it easier for a content creator and a media/streaming content provider to integrate the haptic sense in a standardized manner and improve overall user experience.

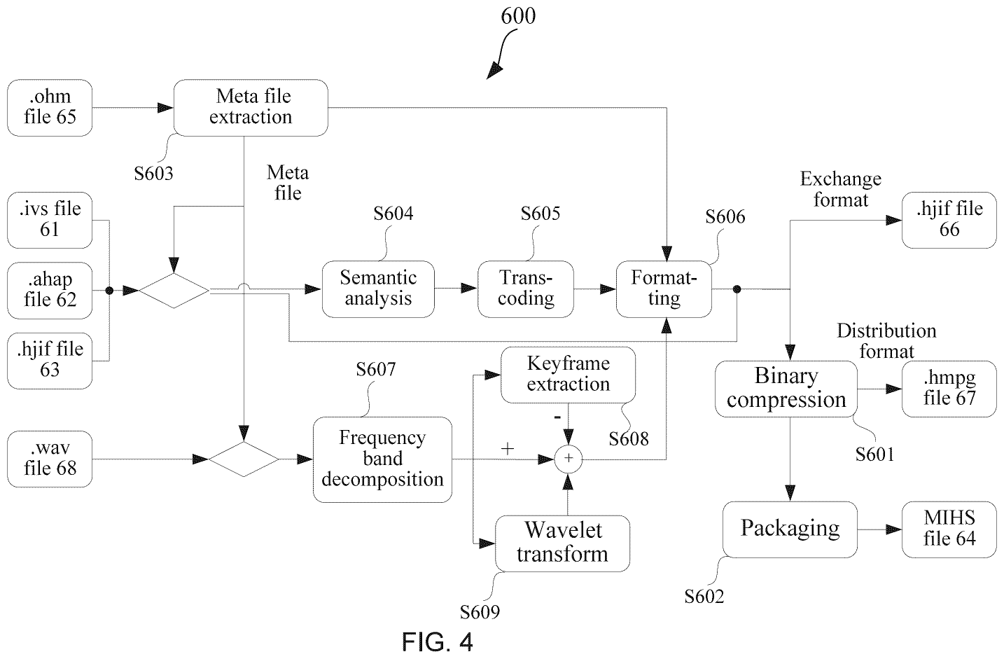

A codec architecture proposed by Working Group 7 of the ISO/IEC MPEG in developing an ISO/IEC 23090-31 haptic encoding and decoding standard may be a pulse code modulation (PCM) file (WAV files/. wav files), and may also process a descriptive haptic file (AHAP file/. ahap file or IVS file/. ivs file or HJIF file/. hjif file). The metadata information is provided to a codec in a format of an .ohm file. The haptic encoding representation allows descriptive and quantitative data to be encoded in a human-readable JSON format, and an encoding process is shown in FIG. 4.

FIG. 4 is a schematic flowchart of encoding the haptic signal. As shown in FIG. 4, a haptic signal encoder 600 processes a PCM haptic file and a descriptive haptic file in different ways. For the descriptive haptic file (an .ivs file 61 or an .ahap file 62, or an .hjif file 63), the haptic signal encoder 600 first recognizes a format of the haptic file. If a to-be-encoded haptic file is the .hjif file 63, no transcoding is required, and the .hjif file 63 and a meta file are directly packaged into an MIHS file 64 through a binary compression step S601 and a packaging step S602. The meta file is obtained by performing meta file extraction on the .ohm file 65 through a meta file extraction step S603. If a to-be-encoded haptic file is the .ahap file 62 or the .ivs file 61, transcoding is required. The haptic signal encoder 600 first analyzes the to-be-encoded haptic file semantically through a semantic analysis step S604, and then transcodes and formats the to-be-encoded haptic file into the data model shown in FIG. 2 through a transcoding step S605 and a formatting step S606. Transcoded data may be exported as an exchange file format (.hjif) 66 encoded in a JSON readable form, a distribution format (.hmpg) 67 encoded as a compressed binary file, or a stream format (MIHS) 64 for defining a data packet-based bitstream. A signal analysis process of the haptic signal encoder 600 for a PCM file (.wav) 68 is divided into two sub-processes. In a first sub-process, a frequency band decomposition step S607 is performed on an original signal, and then a low-frequency signal obtained from frequency band decomposition is encoded based on a keyframe extraction step S608. In a second sub-process, the low-frequency signal is reconstructed, a residual between a reconstructed low-frequency signal and the original low-frequency signal is calculated, and a residual signal is obtained. Then, the residual signal is added to the original high-frequency signal and encoded through a wavelet transform step S609 to output an encoding result in at least one format of the hjif file 66, the .hmpg file 67, or the MIHS file 64.

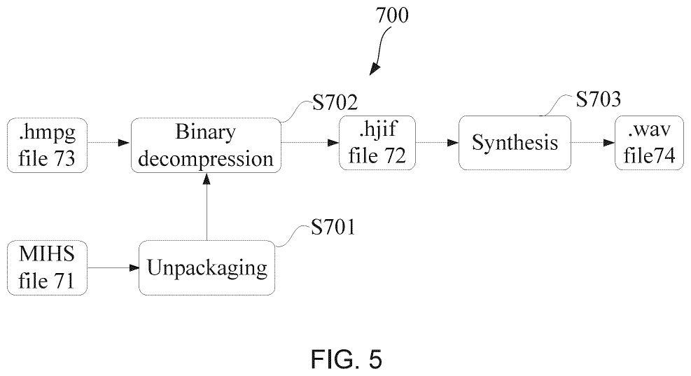

FIG. 5 is a schematic flowchart of decoding the haptic signal. As shown in FIG. 5, a haptic signal decoder 700 may perform, through an unpacking step S701 and a binary decompression step S702, unpacking and decompression on a stream format input (MIHS file 71) packaged into a data packet to obtain an .hjif file 72, and may also select an .hmpg file 73 as an input, and decompress the input through the binary decompression step S702 to output the .hjif file 72. Then, haptic data included in the .hjif file 72 may be directly presented on the haptic device, or an intermediate synthesizer that generates PCM data may be used to output a .wav file 74 through a synthesis step S703 for rendering on the haptic device. An .hjif format is a JSON-based human-readable format and has not been optimized for memory usage. The .hjif format may be easily parsed and manually edited, facilitating content design and creation, and therefore becomes an ideal exchange format. For a distribution purpose, .hjif data may be compressed into a more memory-efficient binary .hmpg bitstream. This compression is lossy, and different parameters may affect encoding depths of an amplitude and a frequency that make up a bitstream. For a streaming transmission purpose, data may be compressed and packaged into an MPEG-I haptic stream (MIHS). This method can meet expectations of related technologies for compatibility with descriptive and quantitative formats of the haptic media file, as well as interoperability between haptic terminal devices, to achieve 3D immersive experience and the distribution purpose. The MIHS is also a basis for encapsulating the haptic media file into the ISOBMFF.

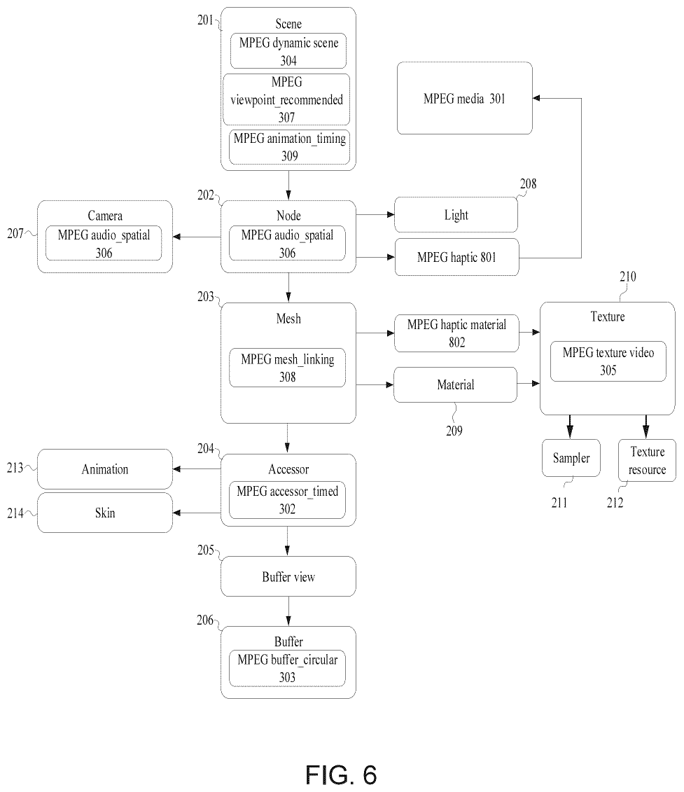

In some embodiments, referring to FIG. 6, in order to associate the haptic media file with an object in the scene and incorporate the haptic sense as a part of immersive media experience, a proposal is approved at the 140th MPEG meeting to add MPEG haptic (MPEG_haptic) 801 and an MPEG haptic material (MPEG_material_haptic) 802 to the MPEG scene description document (the scene description document shown in FIG. 3). In a new version of a haptic extension based on the glTF, the haptic support may be enabled in scene description. The MPEG haptic 801 may index the accessor description module in an accessor list of the scene description document to obtain description information of an accessor for accessing rendering data that is of the haptic media file and stored in the buffer. The MPEG haptic material (MPEG_material_haptic) 802 is a lower-level description module of the mesh description module and configured to support the user to obtain a corresponding haptic feedback through active and/or passive interaction in a virtual scene.

Texture mapping is a technique that efficiently and realistically displays details of a 3D model without a need for a high-resolution mesh. This method is originally developed in computer graphics and is now widely used in haptic rendering. The texture mapping may enable a virtual object to enhance an additional haptic material attribute distributed on a surface of the virtual object, thereby increasing authenticity of the virtual object. Based on the texture mapping, a concept of a haptic material is further proposed in related technologies. In the computer graphics, a material is an easy-to-use data packet that includes all data required for visually rendering the virtual object. By analogy, the haptic material should provide all necessary elements for the haptic rendering, and different haptic materials contain different haptic features. Different haptic material attributes are stored in different haptic material packages, which facilitates related tasks of haptic design and implementation. The haptic material attributes are defined in following Table 2.

TABLE 2

| | | Default | |
|---|---|---|---|
| Name | Data type | value | Description |
| Stiffness | Array | 0 | Defines perception stiffness of the object surface. Force |
| | | | perceived by the user is opposite to force exerted by a body |
| | | | part on the object. This attribute is described using a texture |
| | | | that stores a stiffness coefficient. A rendering model is: |
| | | | F = kx, where k represents a stiffness value of a displacement |
| | | | x along the stiffness attribute. The rendering model is |
| | | | applicable to various isotropic materials |
| Friction | Array | 0 | Defines perceived friction, which is a type of force that |
| | | | impedes sliding of the body part on the object surface. |
| | | | This attribute is described using a texture that stores a |
| | | | friction coefficient. A rendering model is: Ff = μ*F, where μ |
| | | | represents the friction coefficient, and F represents the force |
| | | | exerted by the body part on the object surface |
| Haptic | Array | 0 | Defines a texture perceived by the body part when sliding on |
| texture | | | a physical surface |
| Temperature | Array | 0 | Defines a perceived temperature of the object. This attribute |
| | | | is described using a texture that stores a temperature |
| | | | distribution |
| Vibration | Array | 0 | Defines a vibration signal. This attribute is described using a |
| | | | texture that stores an amplitude and/or a frequency of a |
| | | | signal |
| Custom | Array | 0 | Defines a texture of customized haptic data |

Each haptic material attribute in Table 2 is represented by a texture array, and texture arrays of different attributes are combined to form a specific haptic perception. The haptic material attribute may serve as a traditional 2D texture to provide a relevant haptic texture value, and may also serve as a haptic element map. Each pixel in the haptic element map includes a plurality of haptic unit elements, and is associated with a sequential index of a corresponding haptic object (hapticObject) in the MPEG haptic (MPEG_haptic). The rendering engine may select a most suitable texture array for rendering. In this way, each array element includes a haptic texture and an enumerated texture type. An enumerated haptic material texture type includes:

High_resolution: The haptic texture is a high-resolution 2D texture that directly stores a haptic value.

Low_resolution: The haptic texture is a low-resolution 2D texture that directly stores the haptic value.

Reference: The haptic texture is a 2D haptic element map that includes a haptic signal reference. Each pixel in the haptic texture corresponds to a sequential index of an accessor in the haptic object (hapticObject) in the MPEG haptic (MPEG_haptic).

Other: Unknown proprietary texture format.

To explain data included in a 2D texture, it is necessary to specify a bit depth and a range of the 2D texture. Tables 3 and 3 below show a bit depth and a range of each haptic material attribute for a low-resolution haptic texture and a high-resolution haptic texture, respectively.

TABLE 3

| | Bit | | |
|---|---|---|---|
| Name | depth | Range | Resolution |
| Stiffness | 8-bit | 0-10000N · s⁻¹/m · s⁻¹ | 40N · s⁻¹/m · s⁻¹ |
| Friction | 8-bit | ±5 | 0.04 |
| Vibrotactile texture | 8-bit | ±10 | 0.08 |
| Temperature | 8-bit | [−50:+75]° C. | 0.5° C. |
| Vibration | 8-bit | [0-1] | 0.004 |
| custom | 8-bit | 0-255 | 1 |

TABLE 4

| Name | Bit depth | Range | Resolution |
|---|---|---|---|
| Stiffness | 16-bit | 0-10000N · s⁻¹/m · s⁻¹ | 40N · s⁻¹/m · s⁻¹ |
| Friction | 16-bit | ±5 | 0.003 |
| Vibrotactile | 16-bit | ±10 | 0.0015 |
| texture | | | |
| Temperature | 16-bit | [−50:+75]° C. | 0.004° C. |
| Vibration | 8-bit | [0-1] [0-300] Hz | 0.004 1.17 Hz |
| | (amplitude) | | |
| | 8-bit | | |
| | (frequency) | | |
| custom | 8-bit | 0-65535 | 1 |

As shown in Table 4, a value of a pixel mapped to each texture in a high-resolution vibration texture is divided into two bytes: a first byte is used to describe an amplitude value, and a second byte is used to describe a frequency value.

Syntax elements in the MPEG haptic material (MPEG_material_haptic) 802 are defined in following Table 5:

TABLE 5

| Name | Data type | Default value | Usage | Description |
|---|---|---|---|---|
| Stiffness | Array | N/A | Compulsory | Defines a type of a stiffness material |
| | | | | in the haptic material attribute |
| Friction | Array | N/A | Compulsory | Defines a type of a friction material |
| | | | | in the haptic material attribute |
| Vibrotactile | Array | N/A | Compulsory | Defines a type of a haptic texture |
| texture | | | | material in the haptic material |
| | | | | attribute |
| Temperature | Array | N/A | Compulsory | Defines a type of a temperature |
| | | | | material in the haptic material |
| | | | | attribute |
| Vibration | Array | N/A | Compulsory | Defines a type of a vibration |
| | | | | material in the haptic material |
| | | | | attribute. |
| custom | Array | N/A | Compulsory | Defines a type of a customized |
| | | | | material in the haptic material |
| | | | | attribute |

Table 5 shows semantic meanings of the syntax elements included in the MPEG haptic material (MPEG_material_haptic) 802, and the enumerated values in Table 5 are the haptic material attributes included in Table 2. The MPEG haptic material (MPEG_material_haptic) 802 in the MPEG scene description document may associate the object in the scene with the haptic material, and the user may obtain a corresponding haptic perception when interacting with the object.

Each haptic material attribute includes different haptic features, but is internally stored in a same manner. Table 6 takes the stiffness in the haptic material attribute as an example to further describe stiffness (MPEG_material_haptic.stiffness) enumerated in the MPEG haptic material.

TABLE 6

| Element | | | | |
|---|---|---|---|---|
| name | Data type | Default value | Usage | Description |
| Texture | Array | N/A | Compulsory | Defines a stiffness texture, which is |
| | | | | described as a stiffness coefficient |
| | | | | that is stored by the 2D texture. For a |
| | | | | specific definition of the syntax |
| | | | | element, reference is made to Table 6. |
| type | String | High_resolution | Compulsory | Defines a texture type, including |
| | | | | High_resolution, Low-resolution, and |
| | | | | Reference. |

Referring to FIG. 1, in the working process of the scene description framework for the immersive media, the display engine 11 is mainly used to obtain the scene description document, parse the obtained scene description document to obtain a composition structure of a 3D-scene-to-be-rendered and detailed information in the 3D-scene-to-be-rendered, and render and display the 3D-scene-to-be-rendered based on the information obtained by parsing the scene description document. In the embodiments of the present disclosure, a specific working process and principle of the display engine 11 are not limited. The display engine 11 may parse the scene description document, issue the instruction to the MAF 12 through the MAF API, issues an instruction to a buffer management module 13 through a buffer API, retrieve processed data from the buffer, and render and display the 3D scene and its object.

As shown in FIG. 6, at present, the 140th MPEG meeting approves the proposal to add the MPEG haptic (MPEG_haptic) 801 and the MPEG haptic material (MPEG_material_haptic) 802, and allows the MPEG haptic 801 to be indexed to the accessor description module in the accessor list of the scene description document to obtain haptic rendering data of the haptic media file. The haptic rendering data of the haptic media file mostly describes overall haptic experience related to an event or an environment. The haptic rendering data of the indexed haptic media file is regarded as the haptic signal, which may essentially and directly drive the haptic device to generate a corresponding haptic feedback on the human body.

As described above, in relevant technologies, each array element includes a haptic texture and an enumerated type of the haptic material attribute, and the type of the haptic material attribute includes the High_resolution, the Low_resolution, the Reference, and the Other. When the type of the haptic material attribute is the High_resolution or the Low_resolution, a texture image or the haptic texture material data packet that is indexed by the texture stores the haptic value instead of a color value. The haptic value only represents a size of a specific attribute (such as a size of the friction coefficient and a size of the stiffness coefficient), and may be directly obtained by the display engine for the haptic rendering. However, when the type of the haptic material attribute is the Reference, each pixel in the texture image or the haptic texture material data packet does not directly store the haptic value. Each pixel in the texture image or the haptic texture material data packet points to one haptic media accessor, and a haptic value of a haptic material attribute whose type is the Reference needs to be obtained from the haptic media file. Therefore, how to support the haptic media file in the scene description framework to support the haptic material attribute whose type is the Reference has become one of research hotspots in this field.

Some embodiments of the present disclosure provide a scene description framework supporting a haptic media file, including: support by a scene description document for the haptic media file, support by a MAF API for the haptic media file, support by a MAF for the haptic media file, support by a buffer API for the haptic media file, support by buffer management for the haptic media file, and other content.

A process of indexing a haptic media file in a 3D scene based on the scene description framework and rendering and displaying the 3D scene based on the haptic media file is as follows: Firstly, a display engine downloads, through a network protocol, the scene description document provided by a 3D scene provider, or reads the scene description document from a local memory. The scene description document obtained by the display engine includes description information of the 3D scene and description information of the haptic media file in the 3D scene. The description information of the haptic media file includes an access address of the haptic media file, attribute information (a media type, a codec parameter used, and the like) of the haptic media file, and the like. In addition, a format requirement of haptic rendering data obtained by decoding the haptic media file is also included. The format requirement of the haptic rendering data obtained by decoding the haptic media includes a format requirement (a data type, a data length, a data access method, and the like) of information data such as a description part and an encoding part (namely, the description part 41 and the encoding part 42 in FIG. 2, which are collectively referred to as the haptic media file in the following description) of haptic data obtained by processing the haptic media file, and a format requirement and an address of other media data, including description information of a texture resource and a haptic material attribute that need to be subsequently used, and other data. After parsing the scene description document, the display engine calls the MAF API to transfer the access address of the haptic media file, the attribute information (the media type, a codec used, and the like) of the haptic media file, and other information to the MAF. In addition, the display engine transfers format requirements of specific decoded haptic media data and other media data in the parsed scene description document to the MAF by calling the MAF API. Then, based on the access address that is of the haptic media file and transferred by the display engine, the MAF requests to download the haptic media file from a server or locally obtains the haptic media file. Afterwards, the MAF establishes a corresponding pipeline for the haptic media file based on the media type, the codec parameter, and other information, and converts obtained media data from an encapsulation format to a format required in the scene description document, that is, converts the haptic media file into the format (the data type, the data length, the data access method, and the like) specified in the scene description document in the corresponding pipeline. The haptic media file may be decapsulated, decrypted, decoded, and post-processed in the pipeline. Subsequently, the pipeline stores the haptic rendering data that is of the haptic media file and in the format specified in the scene description document and other media data in a buffer. The buffer may be created by the display engine by calling a buffer management module through the buffer API. If the display engine has not created the buffer, the MAF may invoke the buffer management module through the buffer API to create the buffer. In this way, the buffer may be created, updated, and released. Finally, in the buffer, the display engine reads the haptic rendering data of the haptic media file in the format specified in the scene description document to render a haptic part in the 3D scene.

The following separately describes the scene description document, the MAF API, the MAF, the buffer API, and the buffer management that support the haptic media file.

1. Scene Description Document that Supports the Haptic Media File

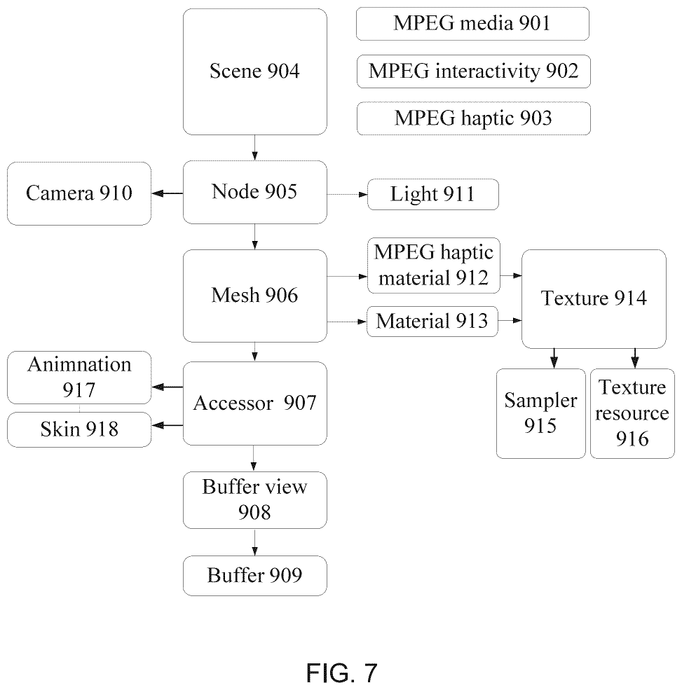

FIG. 7 is a schematic structural diagram of the scene description document that supports the haptic media file according to an embodiment of the present disclosure. As shown in FIG. 7, the scene description document that supports the haptic media file includes but is not limited to: an MPEG media description module (MPEG_media) 901, an MPEG interactivity description module (MPEG_interactivity) 902, an MPEG haptic description module (MPEG_haptic) 903, a scene description module (scene) 904, a node description module (node) 905, a mesh description module (mesh) 906, an accessor description module (accessor) 907, a buffer view description module (bufferView) 908, a buffer description module (buffer) 909, a camera description module (camera) 910, a light description module (light) 911, an MPEG haptic material (MPEG_material_haptic) 912, a material description module (material) 913, a texture description module (texture) 914, a sampler description module (sampler) 915, a texture resource description module (image) 916, an animation description module (animation) 917, and a skin description module (skin) 918. The following describes in detail each part in the scene description modules shown in FIG. 7.

In order to enable the scene description document to correctly describe relevant information of the haptic media file in the 3D scene, some embodiments of the present disclosure extend a value of a syntax element in the MPEG media description module (MPEG_media) 901 in the scene description document, and at least one of following extensions is included:

Extension 1: A value of a media type syntax element (mimeType) used to declare a media resource type of a media file of media in an alternative version list (alternatives) of a media list (media) of the MPEG media description module (MPEG_media) in the scene description document is extended. The extension of the media type syntax element (mimeType) includes adding a value associated with the haptic media file to the media type syntax element (mimeType). For example, in a case where the media list of the MPEG media description module in the scene description document includes haptic media, and the value of the media type syntax element (mimeType) used to declare the media resource type of the media file follows a relevant provision in an ISO/IEC 23090-32 standard, when the media file includes audio data, video data, and haptic data, the value of the media type syntax element (mimeType) is “video/mp4”; when the media file includes only the audio data and the haptic data, the value of the media type syntax element (mimeType) is the “video/mp4”; and when the media file includes only the haptic data, the value of the media type syntax element (mimeType) is “haptics/mp4”.

Extension 2: A value of a first track index syntax element (track) used to declare track information of the media file in a track array (tracks) of the alternative version list (alternatives) of the media list (media) of the MPEG media description module (MPEG_media) in the scene description document is extended. The extension of the first track index syntax element (track) includes: When an encoded haptic media file is referenced by the scene description document as an item in an array of the alternative version list of the media list of the MPEG media description module, a selection method of a reference track in the ISO/IEC 23090-32 standard should be followed. For example, when the haptic media is encapsulated into one MIHS track by using an ISOBMFF, the one MIHS track should be referenced in the MPEG media description module. When the haptic media is encapsulated into a plurality of MIHS tracks by using the ISOBMFF, reference should be made to subsequent supplementary content of the ISO/IEC 23090-32 standard.

Extension 3: A value of a codec parameter syntax element (codecs) used to declare a codec type of media data included in a bitstream track in the track array (tracks) of the alternative version list (alternatives) of the media list (media) of the MPEG media description module (MPEG_media) in the scene description document is extended. A codec parameter of a media file included in the bitstream track is defined in IETFRFC 6381. When the bitstream track includes different types of codecs (for example, AdaptationSet includes representations for different codecs), the codec parameter syntax element (codecs) may be represented by a list of codec values separated by a comma. That is, the extension of the value of the codec parameter syntax element (codecs) includes: When the media data is the haptic data and its encapsulation follows the ISO/IEC 23090-32 standard, the value of the codec parameter syntax element (codecs) should be set according to a provision in a standard for carriage of haptics data in the ISO/IEC 23090-32 standard. For example, when the haptic data is encapsulated by using an ISMBOFF, a first group of elements in the codec parameter syntax element (codecs) represents a code of a codec in an ISO/IEC 23090-31 standard. A parameter of the codec parameter syntax element (codecs) and its form are “codecs”: “mih1.00”, where “mih1” represents a type of data format description for encapsulating the haptic data in the ISOBMFF. This value is not unique and may be replaced by another sample format name that complies with ISOBMFF encapsulation. “oo” represents an object type indication value defined on an “Object Type” page at a website of the MP4 registration authority.

That is, in order to enable the scene description document to correctly describe the haptic media file, some embodiments of the present disclosure extend a value of a syntax element in the MPEG media description module (MPEG_media) in the scene description document, and at least one of syntax elements shown in following Table 7 is specifically extended:

TABLE 7

| Syntax | | | | |
|---|---|---|---|---|
| element | | Default | | |
| name | Data type | value | Usage | Description |
| mimeType | String | N/A | Compulsory | When a media resource includes an audio resource, |
| | | | | a video resource, and a haptic resource, the value of |
| | | | | the “mimeType” is the “video/mp4”. |
| | | | | When a media resource includes only the audio |
| | | | | resource and the haptic resource, the value of the |
| | | | | “mimeType” is the “video/mp4”. |
| | | | | When a media resource includes only the haptic |
| | | | | resource, the value of the “mimeType” is the |
| | | | | “haptics/mp4”. |
| track | String | N/A | Compulsory | When the haptic data is referenced by the scene |
| | | | | description document as an item in the |
| | | | | MPEG_media.alternative.tracks, and the referenced |
| | | | | item complies with a provision of the track in the |
| | | | | ISOBMFF: |
| | | | | For haptic media data encapsulated into a single |
| | | | | track, a single track of a haptic media encapsulation |
| | | | | file is referenced in the MPEG_media. |
| | | | | For haptic data encapsulated into a plurality of |
| | | | | tracks, a reference track referenced in the |
| | | | | MPEG_media should be selected according to a |
| | | | | relevant provision in the ISO/IEC 23090-32 |
| | | | | standard. |
| codecs | String | N/A | Compulsory | When the media data is the haptic data, the value of |
| | | | | the ‘codecs' should be set according to the provision |
| | | | | in the standard for carriage of haptics data in the |
| | | | | ISO/IEC 23090-32 standard. |

It should be noted that the haptic media file is encapsulated based on a data structure shown in FIG. 2. The haptic media file not only includes an information part, but also allows for a metadata configuration part. An encapsulation method of the haptic media file is not limited in the embodiments of the present disclosure, and an encoded and encapsulated haptic media file may be obtained based on the access address of the haptic media file in the MPEG media description module.

In order to enable the scene description document to correctly describe relevant haptic information in the 3D scene, some embodiments of the present disclosure independently extend the MPEG interactivity description module (MPEG_interactivity) 902 in the scene description document. The MPEG interactivity description module (MPEG_interactivity) 902 is configured to describe interaction triggering, an interaction action, and a correlation between the interaction triggering and the interaction action. First-level syntax elements in the MPEG interactivity description module (MPEG_interactivity) 902 are defined in following Table 8:

TABLE 8

| Syntax | | |
|---|---|---|
| element | Data | |
| name | type | Description |
| triggers | Array | Includes definitions of all triggers used |
| | | in the 3D scene. |
| actions | Array | Includes definitions of all actions used in the 3D scene. |
| behaviors | Array | Includes definitions of all behaviors used in the scene. |
| | | One behavior consists of a control parameter, a priority |
| | | weight, and an optional interrupt action that are of a |
| | | paired trigger and action. |

It should be noted that Table 8 only lists partial content related to support for the haptic media, and the MPEG interactivity description module (MPEG_interactivity) 902 may also include other first-level syntax elements, which is not limited in the embodiments of the present disclosure.

A syntax element in the triggers in the MPEG interactivity description module (MPEG_interactivity) 902 is defined in following Table 9:

TABLE 9

| Syntax | | |
|---|---|---|
| element | Data | |
| name | type | Description |
| type | Enum | Defines a type of a trigger, including: |
| | | TRIGGER COLLISION, TRIGGER PROXIMITY, |
| | | TRIGGER USER INPUT, and TRIGGER VISIBILITY. |

Syntax elements in the “actions” in the MPEG interactivity description module (MPEG_interactivity) 902 are defined in following Table 10:

TABLE 10

| Syntax element name | Data type | Description |
|---|---|---|
| type | Enum | Defines an action type, including: |
| | | ACTION_ACTIVATE = 0 (setting an activation status of |
| | | a node) |
| | | ACTION_TRANSFORM (setting transformation as a |
| | | node) |
| | | ACTION_BLOCK (preventing node transformation) |
| | | ACTION_ANIMATION (selecting and controlling an |
| | | animation) |
| | | ACTION_MEDIA (selecting and controlling media) |
| | | ACTION_MANIPULATE (selecting a |
| | | to-be-manipulated operation) |
| | | ACTION_SET_MATERIAL (setting a new material as |
| | | a node) |
| | | ACTION_HAPTIC (obtaining haptic feedbacks on a |
| | | group of nodes) |
| | | ACTION_SET_AVATAR (obtaining an avatar-related |
| | | operation) |
| hapticActionNodes | Array | Describes an index of a node corresponding to a haptic |
| | | action (this syntax element is enabled only when the |
| | | action type is the ACTION_HAPTIC). |

Syntax elements in the hapticActionNodes of the “actions” in the MPEG interactivity description module (MPEG_interactivity) 902 are defined in following Table 11:

TABLE 11

| Syntax | Data | |
|---|---|---|
| element name | type | Description |
| triggers | Array | Describes an index value of a trigger |
| | | description module of a behavior. |
| actions | Array | Describes an index value of an action |
| | | description module of the behavior. |

Syntax elements in the “behaviors” in the MPEG interactivity description module (MPEG_interactivity) 902 are defined in following Table 12:

TABLE 12

| Syntax | Data | |
|---|---|---|
| element name | type | Description |
| triggers | Array | Describes the index value of the trigger |
| | | description module of the behavior. |
| actions | Array | Describes the index value of the action |
| | | description module of the behavior. |

In order to support the haptic media file in the scene description framework, some embodiments of the present disclosure independently extend the MPEG haptic description module (MPEG_haptic) 903 in the scene description document. Compared with the MPEG haptic (MPEG_haptic) 801 in the scene description document shown in FIG. 6, the MPEG haptic description module (MPEG_haptic) 903 in the embodiments of the present disclosure is no longer a lower-level description module of the node description module (node), but a top-level description module in the scene description document. The MPEG haptic description module (MPEG_haptic) 903 is also no longer configured to index a media description module in the media list of the MPEG media description module (MPEG_media) 901, but declares, on a haptic object basis, an accessor for accessing the haptic rendering data of the haptic media file. A top-level syntax element in the MPEG haptic description module (MPEG_haptic) 903 is defined in following Table 13:

TABLE 13

| Syntax | Data | |
|---|---|---|
| element name | type | Description |
| HapticObject | Array | Provides a haptic element list |
| | | to enable haptic support. |

A syntax element in the “hapticObject” of the MPEG haptic description module (MPEG_haptic) 903 is defined in following Table14:

TABLE 14

| Syntax | | |
|---|---|---|
| element | Data | |
| name | type | Description |
| accessor | Array | Includes an index value of an accessor description |
| | | module corresponding to an accessor for accessing |
| | | decoded data from at least one media source in an |
| | | MPEG media.media array. |

In some embodiments, description methods of the scene description module (scene) 904 and the node description module (node) 905 in the scene description document that supports the haptic media file include: when the haptic media file is included in the 3D scene, using scene and node description methods to describe an overall structure of the 3D scene, as well as a structural hierarchy and a position of the haptic media file in the 3D scene. Each 3D scene is described using one independent scene description module. In the 3D scene, there may be many specific objects, such as a virtual digital human, a nearby 3D object, a distant background image, and a virtual camera representing a user's viewpoint and viewing angle. The scene description document uses these specific objects as nodes in the 3D scene, and each node may represent one object or an object set composed of a plurality of objects. A relationship between nodes reflects a relationship between various components in the 3D scene. Each scene description document may describe at least one 3D scene, and there is only a parallel relationship instead of a hierarchical relationship between 3D scenes, that is, there is no inclusion relationship between the 3D scenes. There may be a parallel or hierarchical relationship between the nodes, that is, there is an inclusion relationship between the nodes. In this way, a plurality of specific objects may be integrated together for representation. If one node is included in another node, the included node is referred to as a child node, and the child node is represented by “children” instead of “node”. A hierarchical node structure may be formed by flexibly combining the node and the child node.

In some embodiments, a description method of the mesh description module (mesh) 906 in the scene description document that supports the haptic media file includes: describing, by the scene description document by using a data format of a 3D mesh, in other words, by using the mesh description module (mesh) 906, a node representing a 3D object. The mesh description module includes various types of specific information, such as a 3D coordinate and a color. The above information belongs to a syntax element in an attribute (mesh.primitives.attribute) of a primitive of the mesh description module (mesh). A most basic mesh description module includes a 3D coordinate of a vertex, a connection relationship between vertices, color information of the vertex, and a 3D coordinate of a required texture value. In the mesh description module, it is necessary to enable a texture coordinate (Texcoord) of a 3D coordinate set of the required texture value, such that a haptic value obtained from a texture may be subsequently attached to a corresponding 3D coordinate of the 3D object. The texture coordinate (Texcoord), color data, and other information belong to the attribute (mesh. primitives. attribute) of the primitive of the mesh description module. However, the haptic media does not need to be defined temporarily in the mesh description module by referencing the attribute (attribute) such as a color count. It is only required to enable the MPEG haptic material description module (MPEG_material_haptic) 912 as a content supplement parallel to the material description module (material) 913 to support further definition of a haptic material.

In some embodiments, description methods of the material description module (material) 913 and the texture description module (texture) 914 in the scene description document that supports the haptic media file include: describing additional information of a surface of the 3D object through the material description module (material) 913 and the texture description module (texture) 914. When a conventional 3D object is described, if only geometric information of the 3D object is described with the help of the mesh description module, or a color of a vertex of the 3D mesh is defined monotonously, it is far from enough to enhance authenticity of a virtual object. Therefore, more information needs to be added to a surface of the 3D object. For a conventional 3D modeling technique, this process may also be referred to as texture mapping, texture addition, or the like. That is, the scene description document that supports the haptic media file is based on glTF2.0, and the material description module (material) 913 and the texture description module (texture) 914 are continuously used. In addition, a cooperative relationship between the material description module (material) 913 and the texture description module (texture) 914 includes: The material description module (material) 913 and the texture description module (texture) 914 jointly define color and physical information of an object surface. Under the texture description module (texture) 914, the sampler description module (sampler) 915 and the texture resource description module (image) 916 are specified. The sampler description module (sampler) 915 defines how to map a texture image onto the object surface, achieving specific adjustment and packaging of the texture. The texture resource description module (image) 916 uses a ULR to identify and index the texture resource.

In some embodiments, a description method of the MPEG haptic material description module (MPEG_material_haptic) 912 in the scene description document that supports the haptic media file includes: further describing the haptic material attribute through the MPEG haptic material description module (MPEG_material_haptic) 912. When the haptic media file is included in the 3D scene, it is necessary to consider the haptic material attribute in a material characteristic. The MPEG haptic material description module (MPEG_material_haptic) 912 includes haptic material attribute description modules corresponding to various haptic material attributes (stiffness, friction, haptic texture, temperature, vibration, and custom). The haptic material attribute description module includes an attribute type syntax element (type), and a value of the attribute type syntax element may be High_resolution, Low_resolution, or Reference. An object including a haptic feedback in the 3D scene may include different types of haptic material attributes. For different haptic material attributes on a same object, haptic values or haptic media perceived by the user for the haptic values may be obtained in different ways, in order to associate the haptic media in the scene description document to obtain the haptic feedback.

It may be seen from Table 6 that the MPEG haptic material description module (MPEG_material_haptic) 912 includes the haptic material attribute description modules corresponding to the haptic material attributes (the stiffness, the friction, the haptic texture, the temperature, the vibration, and the custom). A haptic material attribute description module corresponding to each haptic material attribute includes a type of the haptic material attribute, specifically including the High_resolution, the Low_resolution, the Reference, or Other. If a type of a haptic material texture of a haptic material attribute is the Low_resolution or the High_resolution, it means that a haptic value on a texture coordinate point may be obtained from a texture image or another haptic texture material data packet. A value included in each pixel of the texture image or the haptic texture material data packet represents the haptic value. In addition, as shown in Table 4 and Table 5, haptic values of different types of haptic material textures have different bit depths. For example, a bit depth of a haptic value of a haptic material attribute whose type is the High_resolution is 16 bits, while a bit depth of an attribute value of a haptic material attribute whose type is the Low_resolution is 8 bits. If the type of the haptic material attribute is the Reference, it is required that the haptic value of the texture coordinate point or haptic values of a group of texture coordinate points may be indexed to a group of temporal or spatial haptic values. At this time, a relevant supplementary description may be provided through the MPEG interactivity description module (MPEG_interactivity) 902 and the MPEG haptic description module (MPEG_haptic) 903. The MPEG interactivity description module 902 and the MPEG haptic description module 900 are enabled when the haptic media file is included in the scene description document. The MPEG haptic material description module (MPEG_material_haptic) 912 includes a type of each haptic material attribute internally.

In some embodiments, description methods of the accessor description module (accessor) 907, the buffer view description module (bufferView) 908, and the buffer description module (buffer) 908 in the scene description document that supports the haptic media file include: pointing to, based on a value of a media index syntax element (buffer.MPEG_buffer_circular.media) of an MPEG circular buffer of the buffer description module, a media description module corresponding to the haptic media file in the MPEG media description module (MPEG_media). That is, the haptic media file needs to be specified in the buffer description module (buffer), but a URL of the haptic media file is not directly added to the buffer description module (buffer). Instead, an index value of the media description module corresponding to the corresponding haptic media file in the MPEG media description module (MPEG_media) is declared by the media index syntax element (MPEG_buffer_circular.media) in the MPEG circular buffer of the buffer description module (buffer).

For example, if the media description module corresponding to the haptic media file in the MPEG media description module (MPEG_media) is a third media description module in the media list of the MPEG media description module (MPEG_media), the value of the media index syntax element (buffer.MPEG_buffer_circular.media) in the MPEG circular buffer of the buffer description module may be set to “2”, such that an access address of the third media description module in the MPEG media description module is indexed in the MPEG circular buffer of the buffer description module, so as to index the haptic media file based on the media index syntax element in the MPEG circular buffer (MPEG_buffer_circular) of the buffer description module.

In some embodiments, description methods of the accessor description module (accessor) 907, the buffer view description module (bufferView) 908, and the buffer description module (buffer) 908 in the scene description document that supports the haptic media file include: indicating, through a track (buffer.MPEG_buffer_circular.tracks.track) in a track array of the MPEG circular buffer of the buffer description module, track information when an encapsulated file of the haptic media file is accessed. Specifically, when the track array (buffer.MPEG_buffer_circular.tracks) of the MPEG circular buffer of the buffer description module includes a plurality of tracks, the pipeline should perform necessary processing on all referenced tracks to generate a data format requested by the buffer description module. If a media file referenced in the track (buffer.MPEG_buffer_circular.tracks) in the track array of the MPEG circular buffer of the buffer description module has a plurality of alternative versions (alternatives), each alternative version (alternatives) should record a selection status of the track. When the track array (buffer.MPEG_buffer_circular.tracks) of the MPEG circular buffer of the buffer description module is not defined, the pipeline should perform necessary processing on all tracks in the MPEG media description module (MPEG_media) to generate the data format requested by the buffer description module (buffer), that is, to guide the buffer description module (buffer) on how to correctly store data in the MPEG media description module (MPEG_media).

Syntax elements included in the MPEG circular buffer (MPEG_buffer_circular) are shown in Table 15.

TABLE 15

| Element | Data | Default | | |
|---|---|---|---|---|
| name | type | value | Usage | Description |
| count | Integer | 2 | Non-compulsory | Indicates a quantity of circular buffer sections included |
| | | | | in the MPEG circular buffer. The MAF may use this |
| | | | | information and establish a corresponding circular |
| | | | | buffer structure for the display engine. |
| media | Integer | N/A | Compulsory | Indicates an index of a media file in the MPEG media, |
| | | | | where the media file may be used as an input media |
| | | | | source in the buffer. |
| tracks | Array | N/A | Non-compulsory | Indicates an index of a track (track) of a media file from |
| | | | | an extension of the MPEG media, where the index may |
| | | | | be used as an input media source in the buffer. |
| | | | | When the syntax element “tracks” is not defined, the |
| | | | | pipeline should perform the necessary processing on all |
| | | | | the tracks in the MPEG media to generate the data |
| | | | | format requested by the buffer, that is, to guide the |
| | | | | buffer on how to correctly store the data in the MPEG |
| | | | | media. |
| | | | | When the syntax element “tracks” includes a plurality of |
| | | | | tracks, the pipeline should perform the necessary |
| | | | | processing on all the referenced tracks to generate the |
| | | | | data format requested by the buffer. |
| | | | | If a media source referenced in the track has a plurality |
| | | | | of alternative versions, each alternative version should |
| | | | | record the selection status of the track. |

That is, based on a value setting rule of the media index syntax element (media) in Table 15, the value of the media index syntax element (media) in Table 15 is set to the index value of the media description module corresponding to the corresponding haptic media file in the MPEG media description module (MPEG_media), so as to index the haptic media file in the buffer description module. That is, based on a value setting rule of the syntax element “tracks” in Table 15, a value of the syntax element “tracks” in Table 15 is set to an index of a track including the haptic media file in the MPEG media description module, so as to index the track of the haptic media file in the buffer description module.

In some embodiments, a description method of the camera description module (camera) 910 in the scene description document that supports the haptic media file includes: defining a viewpoint, a viewing angle, and other viewing related visual information of the node through the camera description module (camera) 910.

In some embodiments, a description method of the animation description module (animation) 917 in the scene description document that supports the haptic media file includes: defining, through the animation description module (animation) 917, an animation added to the node.

In some embodiments, the animation description module (animation) 917 may describe, through at least one of position movement, angle rotation, and size scaling, the animation added to the node.

In some embodiments, the animation description module (animation) 917 may also indicate at least one of start time, end time, and an implementation of the animation added to the node.

That is, in the scene description document that supports the haptic media file, an animation may also be added to a node representing an object in the 3D object. The animation description module (animation) 917 describes, through the position movement, the angle rotation, and the size scaling, the animation added to the node, and may also specify the start time, the end time, and the implementation of the animation.

In some embodiments, a description method of the skin description module (skin) 918 in the scene description document that supports the haptic media file includes: defining a motion and deformation relationship between a 3D mesh mounted on the node and a corresponding skeleton through the skin description module (skin) 918.

For example, the scene description document shown in FIG. 7 is described below with an example of the scene description document.

Main content of the scene description document shown in FIG. 7 is included in a pair of braces from lines 1 to 320 in the above example. The scene description document that supports the haptic media file includes: a digital asset description module (“asset”: { }), a list of extensions used (“extensionsUsed”: [ ]), an extension description module (“extensions”: { }), a scene declaration (scene), a scene list (“scenes”: [ ]), a node list (“nodes”: [ ]), a mesh list (“meshes”: [ ]), a haptic material list (“MPEG_material_Haptic”: [ ]), a texture list (“textures”: [ ]), a texture resource list (“images”: [ ]), a sampler list (“samplers”: [ ]), an accessor list (“accessors”: [ ]), a buffer view list (“buffer Views”: [ ]), and a buffer list (“buffers”: [ ]). The following describes each part and information included in each part from a parsing perspective.

1. Digital asset description module (“asset”: { }): The digital asset description module is located at lines 2 to 4. Based on “version”: “2.0” at line 3 in the digital asset description module, it may be determined that the scene description document is compiled based on the glTF2.0, which is also a reference version of a scene description standard. From the parsing perspective, the display engine may determine a parser based on the digital asset description module to parse the scene description document.

2. List of extensions used (“extensionsUsed”: [ ]): The list of extensions used is located at lines 6 to 13. Because the list of extensions used includes six extensions that respectively involve the MPEG media (MPEG_media), the MPEG interactivity (MPEG_interactivity), the MPEG haptic (MPEG_Haptic), the MPEG haptic material (MPEG_material_Haptic), the MPEG circular buffer (MPEG_buffer_circular), and an MPEG time-varying accessor (MPEG_accessor_timed), it may be determined that the scene description document uses six MPEG extensions that respectively involve the MPEG media (MPEG_media), the MPEG interactivity (MPEG_interactivity), the MPEG haptic (MPEG_Haptic), the MPEG haptic material (MPEG_material_Haptic), the MPEG circular buffer (MPEG_buffer_circular), and the MPEG time-varying accessor (MPEG_accessor_timed). From the parsing perspective, the display engine may learn in advance based on content of the list of extensions that extension items involved in subsequent parsing includes: the MPEG media, the MPEG interactivity, the MPEG haptic, the MPEG haptic material, the MPEG circular buffer, and the MPEG time-varying accessor.

3. Extension description module (“extensions”: { }): An extension list is located at lines 15 to 94. The extension description module includes three extended description modules: the MPEG interactivity description module (“MPEG_interactivity”: { }), the MPEG media description module (“MPEG_media”: { }), and the MPEG haptic description module (“MPEG_haptic”: { }).

3.1. MPEG interactivity description module (“MPEG_interactivity”: { }): The MPEG interactivity description module is located at lines 16 to 60. The MPEG interactivity description module includes three parts: a trigger list (“triggers”: [ ]), an action list (“actions”: [ ]), and a behavior list (“behaviors”: [ ]). The trigger list (“triggers”: [ ]) is located at lines 17 to 24, and includes two parallel braces, indicating that two triggers are declared in the trigger list through two trigger description modules, and “type”: “TRIGGER_COLLISION” at lines 19 and 22 indicates that types of the two triggers are the TRIGGER_COLLISION. The action list (“actions”: [ ]) is located at lines 25 to 51 and includes two parallel braces, indicating that two actions are declared in the action list through two action description modules. A first action description module (content enclosed in a brace at lines 26 to 41) first indicates, through “type”: “ACTION_SET_HAPTIC” at line 27, that a type of an action corresponding to the first action description module is a haptic action, and indicates, through three haptic action node arrays (content enclosed in braces at lines 29 to 32, 33 to 36, and 37 to 39) in a haptic action node list (“hapticActionNodes”: [ ]), that the following nodes need to be enabled for the haptic action: nodes corresponding to node description modules whose index values are 0, 1, and 2 (first, second, and third node description modules in the node list). The node corresponding to the node description module whose index value is 0 needs to enable the haptic media file, and needs to access the haptic rendering data of the haptic media file based on a first haptic object description module (“hapticObject”: [ ]) in the MPEG haptic description module (“MPEG_haptic”: { }). The node corresponding to the node description module whose index value is 1 also needs to enable the haptic media file, and needs to access the haptic rendering data of the haptic media file based on a second haptic object description module (“hapticObject”: [ ]) in the MPEG haptic description module (“MPEG_haptic”: { }). The node corresponding to the node description module whose index value is 3 also needs to enable the haptic media file, but there is no index declaration about a haptic object description module, which indicates that the node corresponding to the node description module whose index value is 3 declares access to the haptic rendering data of the haptic media file through the MPEG haptic material (MPEG_material_Haptic) in a corresponding mesh description module. Content declared by a second action description module (content enclosed in a brace at lines 42 to 50) is similar to the content declared by a first action array. To avoid repetition, details are not described herein again. The behavior list (“behaviors”: [ ]) is located at lines 52 to 59 and includes two parallel braces, indicating that two behaviors are declared in the behavior list through two behavior arrays. A first behavior array (content enclosed in a brace at lines 53 to 55) implements mutual association between a first trigger description module in the trigger list (“triggers”: [ ]) and the first and second action description modules in the action list (“actions”: [ ]) through “triggers”: 0 at line 53 and “actions”: 0.1 at line 54. A second behavior description module implements mutual association between a second trigger description module in the trigger list (“triggers”: [ ]) and the second action description module in the action list (“actions”: [ ]) through “triggers”: 1 at line 56 and “actions”: 1 at line 57.

3.2. MPEG media description module (“MPEG_media”: { }): The MPEG media description module is located at lines 61 to 81. The MPEG media description module declares a media file included in the 3D scene. The media list (“media”: [ ]) of the MPEG media description module includes only one brace (one media description module), indicating that only one media file is declared in the MPEG media in the scene description document. The media description module indicates, through “mimeType”: “video/mp4” at line 69, that a file type of an encapsulated file corresponding to the one media file is MP4, indicates an access address of the one media file through “uri”: “http://www.example.com/Hapticexample.mp4” at line 70, indicates track information of the one media file through “track”: “trackIndex=1” at line 73, indicates decoding information of the one media file through “codecs”: “mih1.00” at line 74, indicates a name of the one media file through “name”: “Hapticexample” at line 64, indicates, through “autoplay”: true at line 65, that the one media file should be automatically played, and indicates, through “loop”: true at line 66, that the one media file should be cyclically played. From the parsing perspective, the display engine may determine existence of one haptic media file in a 3D-scene-to-be-rendered by parsing the MPEG media, and learns a method for accessing and parsing the one haptic media file.

3.3. MPEG haptic description module (“MPEG_haptic”: { }): The MPEG haptic includes two haptic object description modules (“hapticObject”: [ ]). The first haptic object description module declares corresponding accessors of second and fifth accessor description modules in the accessor list through “accessor”: 1,4 at line 85. Combined with content of a haptic action node list of the first action description module in the action list (“actions”: [ ]), it may be learned that the node corresponding to the node description module whose index value is 0 needs to access the haptic rendering data of the haptic media file through the corresponding accessors of the second and fifth accessor description modules in the accessor list. The second haptic object array declares corresponding accessors of third and fourth accessor description modules in the accessor list through “accessor”: 2,3 at line 90. Combined with content of a haptic action node list of the second action array in the action list (“actions”: [ ]), it may be learned that the node corresponding to the node description module whose index value is 1 needs to access the haptic rendering data of the haptic media file through the corresponding accessors of the third and fourth accessor description modules in the accessor list.

4. Scene declaration (scene): The scene declaration is located at line 96. Because one scene description document theoretically may include scene description modules of a plurality of 3D scenes, the scene description document first indicates, through “scene”: 0 at line 96, that a scene to be processed and rendered subsequently (the 3D-scene-to-be-rendered) is a 3D scene corresponding to a first scene description module in the scene list (“scenes”: [ ]) of the scene description document, that is, a scene that is described in the scene description document and enclosed in a brace at lines 99 to 103. From the parsing perspective, the scene declaration clarifies that the scene description framework should select the 3D scene corresponding to the first scene description module in the scene list (“scenes”: [ ]) for subsequent processing and rendering.

5. Scene list (“scenes”: [ ]): The scene list is located at lines 98 to 104. The scene list includes only one brace, indicating that the scene description document includes only one scene description module (scene). The scene description document only describes one 3D scene. In the one brace (scene description module), a node index list at lines 100 to 102 and its content “nodes”: [0,1,2] indicate the one 3D scene includes three nodes, namely the nodes corresponding to the first to third node description modules in the node list (“nodes”: [ ]). From the parsing perspective, the scene list (“scenes”: [ ]) clarifies an overall structure of the one 3D scene and points to a more detailed lower-level node description module (node).

6. Node list (“nodes”: [ ]): The node list is located at lines 106 to 119. The node list includes three braces, indicating that the scene description document includes three node description modules. The 3D scene has three nodes, and the three nodes correspond one-to-one with nodes indexed in the node index list of the unique scene description module in the scene list (“scenes”: [ ]), and the three nodes and the nodes indexed in the node index list are associated through indexing. In the first node description module (content enclosed in a brace at lines 107 to 110), “name”: “Hapticexample_node1” at line 108 indicates that a corresponding node is named “Hapticexample_node1”, and “mesh”: “0” at line 109 indicates that content mounted on the corresponding node is a first 3D mesh in the mesh list (“meshes”: [ ]), which corresponds to a lower-level mesh description module. From the parsing perspective, the first node description module in the node list (“nodes”: [ ]) indicates that the content mounted on the node is the 3D mesh and an index of a mesh description module of the 3D mesh is 0. Content declared by the second node description module (content enclosed in a brace at lines 111 to 114) and content declared by the third node description module (content enclosed in a brace at lines 115 to 118) are similar to the content declared by the first node description module. To avoid repetition, details are not described herein again.

7. Mesh List (“meshes”: [ ]): The mesh list is located at lines 121 to 159 and includes three braces, indicating that the scene description document includes three mesh description modules (mesh). The 3D scene has three 3D meshes, and each 3D mesh is a mesh description module indexed by a node description module based on a mesh index syntax element (“mesh”). In a target mesh description module (content enclosed in a brace at lines 122 to 132), “name”: “Hapticexample_mesh1” at line 123 indicates that the corresponding 3D mesh is named “Hapticexample_mesh1”, which is only used as an identification marker; and “primitives” at line 124 indicates that the corresponding 3D mesh has primitive information, namely primitives. “attributes” at line 126 and “mode” at line 129 respectively indicate existence of attribute information (attribute) and mode information (mode). “TEXCOORD_0”: 0 at line 127 indicates that an accessor corresponding to the texture coordinate is a first accessor description module in the accessor list. “mode”: 0 at line 129 indicates that a topology of the corresponding 3D mesh is a scattered structure. Content declared by a second mesh description module (content enclosed in a brace at lines 133 to 158) and content declared by a third mesh description module (content enclosed in a brace at lines 133 to 132) are similar to the content declared by the first mesh description module, except that the third mesh description module also includes the extension of the MPEG_material_Haptic in a primitive (primitives), and indicates, through an MPEG haptic material description module (“MPEG_material_Haptic”: { }) at lines 153 and 154, that a 3D mesh corresponding to the third mesh description module carries a haptic material attribute and points to a first haptic material array in a more detailed lower-level haptic material list (“MPEG_material_Haptic”: [ ]).

8. Haptic material list (“MPEG_material_Haptic”: [ ]): The haptic material list is located at lines 161 to 187. The haptic material list (MPEG_material_Haptic) includes only one brace, indicating that the scene description document includes only one haptic material array (content enclosed in a brace at lines 162 to 185). The one haptic material array defines three haptic material attributes (namely the stiffness, the temperature, and the vibration) through a haptic material description module at lines 164 to 170, a haptic material description module at lines 171 to 177, and a haptic material description module at lines 178 to 184, respectively. Each haptic material attribute includes two types of information: a texture array (“texture”: { }) and a haptic material type (type). The description module corresponding to the stiffness is located at lines 164 to 170, where “index”: 0 at line 166 defines that the stiffness points to a first texture description module in the texture list; “texCoord”: 0 at line 167 defines that the stiffness uses a texture coordinate accessed by an accessor indexed by a first texture coordinate syntax element (TexCoord_n) in the mesh list as a coordinate reference for performing texture addition on the haptic material attribute; “type”: Low_resolution at line 169 defines that a type of the stiffness is the Low_resolution; and a length of a subsequently obtained haptic value of the stiffness is 8 bits. The description module corresponding to the temperature is located at lines 171 to 177, where “index”: 1 at line 173 defines that the temperature points to a second texture description module in the texture list; and “type”: Reference at line 176 defines that a type of a haptic material texture of the temperature is the Reference. The description module corresponding to the vibration is located at lines 178 to 185, where “index”: 2 at line 180 defines that the vibration points to a third texture description module (texture) in the texture list; and “type”: Reference at line 183 defines that a type of a haptic material texture of the vibration is the Reference. From the parsing perspective, a texture type and source of a haptic material attribute included in an object may be determined based on the haptic material list (MPEG_material_Haptic), and point to a more detailed lower-level texture description module.

9. Texture list (“textures”: [ ]): The texture list is located at lines 189 to 202. The texture list includes three braces, indicating that the scene description document includes three texture description modules, which respectively correspond to the stiffness, the temperature, and the vibration. The texture description modules corresponding to the stiffness, the temperature, and the vibration each include a sampler syntax element (sampler) and a source syntax element (source). Based on values of a sampler index syntax element (sampler) and a texture resource index syntax element (source), access addresses of samplers and texture resources for the stiffness, the temperature, and the vibration may be determined. The access address of the texture resource corresponds to a lower-level texture resource list (“images”: [ ]), and sampler information corresponds to a lower-level sampler list (“samplers”: [ ]).

10. Texture resource list (“images”: [ ]): The texture resource list is located at lines 204 to 214. The texture resource list includes three braces, respectively corresponding to access addresses of texture resources referenced in the texture description modules respectively corresponding to the stiffness, the temperature, and the vibration. Based on {“uri”: “stiffnessTexture.png”} at lines 205 to 207, it may be determined that the access address of the texture resource of the stiffness is stiffnessTexture.png. Based on {“uri”: “temperatureTexture.png”} at lines 208 to 210, it may be determined that the access address of the texture resource of the temperature is temperatureTexture.png. Based on {“uri”: “Texture.png”} at lines 211 to 213, it may be determined that the access address of the texture resource of the vibration is vibration Texture.png.

11. Sampler list (“samplers”: [ ]): The sampler list is located at lines 216 to 221. The sampler list includes one brace, indicating that the scene description document includes one sampler description module. Only one sampler is required to display the 3D scene, and description information of the one sampler may be determined based on “magFilter”: 9729, “minFilter”: 9987, “wrapS”: 33648, and “wrapT”: 33648 at lines 217 to 220.

12. Buffer list (“buffers”: [ ]): The buffer list is located at lines 304 to 319. The buffer list includes two braces, indicating that the scene description document includes two buffer description modules, and two buffers are required to display the 3D scene. Based on a first buffer description module (content enclosed in a brace at lines 305 to 308), it may be determined that a size of a first buffer is 1000, an address of a media file that needs to be stored is “AnimatedBody.bin”, and the media file includes coordinate content of texture information that needs to be added to a specific 3D coordinate. Based on an MPEG circular buffer (“MPEG_buffer_circular”: { }) in a second buffer description module (content enclosed in a brace at lines 309 to 318), it may be determined that a second buffer is a circular buffer reconstructed using an MPEG extension. “media: 0” at line 314 indicates that a data source in the circular buffer is a first media file declared in the MPEG media (MPEG_media). “tracks”: “#trackIndex=1” at line 315 indicates that a track whose index is 1 should be referenced when the haptic media encapsulation file is accessed. Herein, the track whose index is 1 is not limited, and may be a unique track of a haptic file encapsulated into a single track or a reference track of a haptic file encapsulated into a plurality of tracks. In addition, based on “count”: 3 at line 313, it may also be determined that the MPEG circular buffer has three storage stages, and based on “byteLength”: 11000 at line 310, it may also be determined that a byte length (capacity) of the MPEG circular buffer is 11000 bytes. From the parsing perspective, the buffer list enables the haptic media file declared in the MPEG media (MPEG_media) to correspond to a buffer, in other words, enables the buffer to reference a haptic media file that is previously declared but not used. It should be noted that the haptic media file referenced herein is an encapsulated file of an unprocessed haptic media file. The encapsulated file of the haptic media file needs to be processed by the MAF in order to extract information that may be directly used for rendering.

13. Buffer view list (“bufferViews”: [ ]): The buffer view list is located at lines 276 to 302. The buffer view list includes five braces, indicating that the scene description document includes five buffer view description modules. Based on “buffer”: 0 at line 278 in a first buffer view description module (content enclosed in a brace at lines 277 to 281), it may be determined that a buffer view corresponding to the first buffer view description module is a buffer view of a buffer corresponding to the first buffer description module in the buffer list. “byteLength”: 1000 at line 279 and “byteOffset”: 0 at line 280 declare that a data view range of the buffer view is the first 1000 bytes of the first buffer. Based on “buffer”: 1 at line 283 in a second buffer view description module (content enclosed in a brace at lines 282 to 286), it may be determined that a buffer view corresponding to the second buffer view description module is a buffer view of a buffer corresponding to the second buffer description module in the buffer list. “byteLength”: 2000 at line 284 and “byteOffset”: 0 at line 285 declare that a data view range of the buffer view is the first 2000 bytes of the second buffer. Content declared by a third buffer view description module, content declared by a fourth buffer view description module, and content declared by a fifth buffer view description module are similar to the content declared by the second buffer view description module. To avoid repetition, details are not described herein again. From the parsing perspective, the buffer view list groups data of the media file, which is beneficial to refine definition of a subsequent accessor description module.

14. Accessor List (“accessors”: [ ]): The accessor list is located at lines 223 to 274. Structurally similar to the buffer view list, the accessor list also includes five parallel braces, indicating that the scene description document includes five accessor description modules (accessor), and three accessors are required to access the media data to display the 3D scene. The first accessor description module (content enclosed in a brace at lines 224 to 229) indicates, through “bufferView”: 0 at line 225, that an accessor corresponding to the first accessor description module is configured to access a first buffer view in the buffer view list, indicates, through “componentType”: 5121 at line 226, that a data format of data accessed by the accessor corresponding to the first accessor description module is 8-bit unsigned short (unsign short, 8 bits), indicates, through “type”: “VEC2” at line 227, that a type is a 2D vector (VEC2), and indicates, through “count”: 500 at line 228, that 500 pieces of data need to be accessed by the accessor. The second accessor description module (content enclosed in a brace at lines 230 to 240), the third accessor description module (content enclosed in a brace at lines 241 to 251), the fourth accessor description module (content enclosed in a brace at lines 252 to 262), and the fifth accessor description module (content enclosed in a brace at lines 263 to 273) each have the MPEG time-varying accessor (“MPEG_accessor_timed”), indicating that corresponding accessors are all MPEG time-varying accessors, pointing to time-varying media defined by the MPEG. In the second accessor description module, it may be determined based on “bufferView”: 1 at line 236 that the corresponding accessor is configured to access a buffer view corresponding to a second buffer view description module in the buffer view list (“buffer Views”: [ ]); “immutable”: true at line 237 indicates that a syntax element value in the corresponding accessor does not change over time; and “componentType”, “type”, and “count” declare a data type of data accessed by the corresponding accessor, a type of the corresponding accessor, and a count of the data accessed by the corresponding accessor. Content declared by the third accessor description module, content declared by the fourth accessor description module, and content declared by the fifth accessor description module are similar to the content declared by the second accessor description module. To avoid repetition, details are not described herein again. From the parsing perspective, the accessor list provides a complete definition of data required for the rendering, for example, missing data types in the buffer view and the buffer are defined in the corresponding accessor description modules.

2. Display Engine that Supports the Haptic Media File

In a working process of a scene description framework for immersive media, main functions of the display engine include: parsing the scene description document to obtain a 3D scene rendering method; sending a media access instruction or a media data processing instruction to the MAF through the MAF API; sending a buffer management instruction to the buffer management module through the buffer API; and reading processed data from the buffer, and rendering and displaying a 3D scene and an object in the 3D scene based on the read data. Therefore, functions of the display engine that supports the haptic media file include: 1. parsing a scene description document including the haptic media and obtaining a corresponding 3D scene rendering method; 2. transferring a media access instruction or a media data processing instruction to the MAF through the MAF API, where the media access instruction or the media data processing instruction comes from a result of parsing the scene description document including the haptic media; 3. sending a buffer management instruction to the buffer management module through a buffer API; and 4. reading haptic rending data of a processed haptic media file from the buffer, and rendering and displaying a 3D scene and a haptic media file in the 3D scene based on the read haptic rendering data.

3. MAF API that Supports the Haptic Media File

In the working process of the scene description framework for the immersive media, the display engine may obtain the 3D scene rendering method by parsing the scene description document, and needs to transfer the 3D scene rendering method to the MAF or send an instruction to the MAF based on the 3D scene rendering method. A process for transferring the 3D scene rendering method to the MAF or sending the instruction to the MAF based on the 3D scene rendering method is implemented through the MAF API.

In some embodiments, the display engine may send the media access instruction or the media data processing instruction to the MAF through the MAF API. The instruction issued by the display engine comes from a result of parsing the scene description document including the attribute information of the haptic media. The instruction may include an address of the media file, attribute information (a media type, a codec used, and the like) of the media file, a format requirement for processed haptic media data and other media data, and the like.

In some embodiments, the MAF may also request the media access instruction or the media data processing instruction from the display engine through the MAF API.

4. MAF that Supports the Haptic Media File

In the working process of the scene description framework for the immersive media, after receiving the media access instruction or the media data processing instruction that is issued by the display engine through the MAF API, the MAF executes the media access instruction or the media data processing instruction that is issued by the display engine through the MAF API. For example, the MAF obtains the haptic media file, establishes an appropriate pipeline for the haptic media file to convert data in the haptic media file into a format specified in the instruction, and allocates an appropriate buffer configured for haptic media data and other media data that are processed into the format specified in the scene description document.

In some embodiments, that the MAF obtains the haptic media file includes: downloading the haptic media file from the server using a network transmission service.

In some embodiments, that the MAF obtains the haptic media file includes: reading the haptic media file from local storage space.

After obtaining the haptic media file, the MAF needs to process the haptic media file. Processing procedures of different types of media files are significantly different. In order to support a wide variety of media types and consider efficiency of the MAF, a plurality types of pipelines are designed in the MAF, and only a pipeline that matches a media type is enabled during the media file processing.

5. Buffer API that Supports the Haptic Media File

After processing the data in the haptic media file, the MAF also needs to deliver processed data to the display engine in a standardized arrangement structure. Therefore, the processed data needs to be correctly stored in the buffer, which is completed by the buffer management module. However, the buffer management module needs to obtain the buffer management instruction from the MAF or the display engine through the buffer API.

In some embodiments, the MAF may send the buffer management instruction to the buffer management module through the buffer API. The buffer management instruction is sent by the display engine to the MAF through the MAF API.

In some embodiments, the display engine may send the buffer management instruction to the buffer management module through the buffer API.

That is, the buffer management module may communicate with the MAF through the buffer API and may also communicate with the display engine through the buffer API, so as to manage the buffer. When the buffer management module communicates with the MAF through the buffer API, the display engine needs to first send the buffer management instruction to the MAF through the MAF API, and the MAF then sends the buffer management instruction to the buffer management module through the buffer API. When the buffer management module communicates with the display engine through the buffer API, the display engine only needs to generate the buffer management instruction based on buffer management information parsed from the scene description document, and sends the buffer management instruction to the buffer management module through the buffer API.

In some embodiments, the buffer management instruction may include at least one of a buffer creation instruction, a buffer updating instruction, and a buffer releasing instruction.

6. Buffer Management Module that Supports the Haptic Media File

In the working process of the scene description framework for the immersive media, after the MAF processes the data in the haptic media file through the pipeline, the processed data needs to be delivered to the display engine in the standardized arrangement structure. Therefore, the processed data needs to be correctly stored in the buffer, which is completed by the buffer management module.

The buffer management module implements management operations such as buffer creation, updating, and releasing, and instructions for these operations are received through the buffer API. A buffer management rule is recorded in the scene description document, parsed by the display engine, and finally issued to the buffer management module by the display engine or the MAF. After being processed by the MAF, the haptic media file needs to be stored in an appropriate buffer and then retrieved by the display engine. The buffer management is to manage the buffer well, such that the buffer matches a format of processed media data without disrupting the processed media data. A specific method for designing the media management module should be based on designs of the display engine and the MAF.

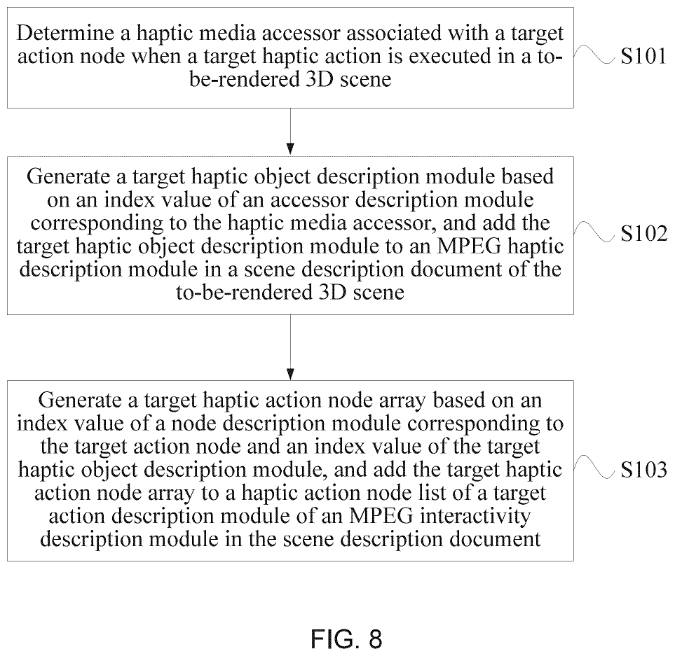

Based on the above content, some embodiments of the present disclosure provide a method for generating a scene description document. Referring to FIG. 8, the method for generating a scene description document includes following steps S101 to S105:

S101: Determine a haptic media accessor associated with a target action node when a target haptic action is executed in a 3D-scene-to-be-rendered.

The haptic media accessor is an accessor configured to access haptic rendering data of a haptic media file declared in an MPEG media description module (“MPEG_media”: { }) associated with the target action node when the target haptic action is executed.

The haptic rendering data in the haptic media file in the embodiments of the present disclosure may be data that is obtained by performing processing such as decapsulation, decoding, decryption, and format conversion on the haptic media file and may be directly used for rendering the 3D scene, or may be data that is obtained by performing other processing on the haptic media file and may be directly used for rendering the 3D scene. The haptic rendering data of the haptic media file may include a haptic value of a haptic material attribute, and the haptic material attribute may include at least one of stiffness, friction, haptic texture (Vibrotactile texture), temperature, vibration, and custom.

It should be noted that when different haptic actions are performed in the 3D-scene-to-be-rendered, haptic rendering data of haptic media files associated with a same node in the 3D-scene-to-be-rendered may be different (haptic media files for rendering the node may include different haptic rendering data). Therefore, when different haptic actions are performed in the 3D-scene-to-be-rendered, haptic media accessors associated with the same node in the 3D-scene-to-be-rendered may be different. For example, when a haptic action A is executed in the 3D-scene-to-be-rendered, haptic media accessors associated with a node 1 in the 3D-scene-to-be-rendered are an accessor 1 and an accessor 2. When a haptic action B is executed in the 3D-scene-to-be-rendered, haptic media accessors associated with the node 1 in the 3D-scene-to-be-rendered are the accessor 2 and an accessor 3. For another example, when a haptic action C is executed in the 3D-scene-to-be-rendered, haptic media accessors associated with a node 2 in the 3D-scene-to-be-rendered are an accessor 0 and the accessor 1. When a haptic action D is executed in the 3D-scene-to-be-rendered, the node 2 in the 3D-scene-to-be-rendered does not need to provide a haptic feedback and does not perform haptic rendering. Therefore, the node 2 is not associated with any haptic media accessor.

It should also be noted that any quantity of haptic media accessors may be associated with the target action node when the target haptic action is executed. That is, there may be at least one haptic media accessor associated with the target action node when the target haptic action is executed.

S102: Generate a target haptic object description module (“hapticObject”: [ ]) based on an index value of an accessor description module corresponding to the haptic media accessor, and add the target haptic object description module to an MPEG haptic description module (“MPEG_haptic”: { }) in a scene description document of the 3D-scene-to-be-rendered.

That is, in order to associate the haptic rendering data of the haptic media file with a node in the 3D scene, the embodiments of the present disclosure introduce a concept of a haptic object (hapticObject) through MPEG haptic (MPEG_haptic), and associate the haptic rendering data of the haptic media file with the node in the 3D scene based on the haptic object.

In some embodiments, the generating a target haptic object description module based on an index value of an accessor description module corresponding to the haptic media accessor includes:

adding an accessor index syntax element (accessor) to the target haptic object description module, and setting a value of the accessor index syntax element to the index value of the accessor description module corresponding to the haptic media accessor.

For example, when there are two haptic media accessors, and index values of accessor description modules corresponding to the two haptic media accessors are respectively 1 and 4, the target haptic object description module generated based on the index value of the accessor description module corresponding to the haptic media accessor may be as follows:

| | |
|---|---|
| n+1 | “hapticObject”:[ |
| n+2 | { |
| n+3 | “accessor”:1,4 |
| n+4 | } |
| n+5 | ], |

As described in the above example, index values of accessor description modules corresponding to a plurality of haptic media accessors may be separated by “,”.

S103: Generate a target haptic action node array based on an index value of a node description module corresponding to the target action node and an index value of the target haptic object description module, and add the target haptic action node array to a haptic action node list (“hapticActionNodes”: [ ]) of a target action description module of an MPEG interactivity description module (“MPEG_interactivity”: { }) in the scene description document.

The target action description module is an action description module corresponding to the target haptic action.

In some embodiments, the generating a target haptic action node array based on an index value of a node description module corresponding to the target action node and an index value of the target haptic object description module includes following steps 1031 and 1032:

Step 1031: Add a node index syntax element (node) to the target haptic action node array, and set a value of the node index syntax element to the index value of the node description module corresponding to the target action node.

Step 1032: Add a haptic object index syntax element (hapticObject) to the target haptic action node array, and set a value of the haptic object index syntax element to the index value of the target haptic object description module.

For example, when the index value of the node description module corresponding to the target action node is 0, and the index value of the target tactile object description module is 1, the target haptic action node array generated based on the index value of the node description module corresponding to the target action node and the index value of the target haptic object description module may be as follows:

| | |
|---|---|
| n+1 | { |
| n+2 | “node”:0 |
| n+3 | “hapticObject”:1 |
| n+4 | }, |

It should be noted that when the target haptic action is executed in the 3D-scene-to-be-rendered, there may be a plurality of nodes that require the haptic rendering, and some nodes obtain the haptic value from the haptic texture (by using a haptic material in a mesh description module of a 3D mesh on which the nodes are mounted), and do not need to associate the haptic object. Therefore, a haptic action node list of the target action description module may include a plurality of haptic action node arrays, and the haptic action node arrays may include a haptic action node array that does not include the haptic object index syntax element (hapticObject).

For example, when a haptic action is executed in the 3D-scene-to-be-rendered, three nodes need to be rendered, namely a node A, a node B, and a node C. Index values of node description modules corresponding to the node A, the node B, and the node C are respectively 0, 1, and 2. An index value of a haptic object description module corresponding to a haptic object associated with the node A is 0, and an index value of a haptic object description module corresponding to a haptic object associated with the node B is 1. The node C obtains a relevant haptic value by using a haptic material in a mesh description module of a 3D mesh mounted on the node C. If no haptic object is associated, a haptic action node list of an action description module corresponding to the haptic action may be as follows:

| | |
|---|---|
| n+01 | “hapticActionNodes”:[ |
| n+02 | { |
| n+03 | “node”:0 |
| n+04 | “hapticObject”:0 |
| n+05 | }, |
| n+06 | { |
| n+07 | “node”:1 |
| n+08 | “hapticObject”:1 |
| n+09 | }, |
| n+10 | { |
| n+11 | “node”:2 |
| n+12 | } |
| n+13 | ] |

Content of lines n+02 to n+05 is a haptic action node array corresponding to the node A, content of lines n+06 to n+09 is a haptic action node array corresponding to the node B, and content of lines n+10 to n+12 is a haptic action node array corresponding to the node C.

When generating the scene description document of the 3D-scene-to-be-rendered, the method for generating a scene description document provided in the embodiments of the present disclosure first determines the haptic media accessor associated with the target action node when executing the target haptic action in the 3D-scene-to-be-rendered, where the haptic media accessor is the accessor configured to access the haptic rendering data of the haptic media file declared in the MPEG media description module associated with the target action node when the target haptic action is executed; generates the target haptic object description module based on the index value of the accessor description module corresponding to the haptic media accessor, and adds the target haptic object description module to the MPEG haptic description module in the scene description document of the 3D-scene-to-be-rendered; and generates the target haptic action node array based on the index value of the node description module corresponding to the target action node and the index value of the target haptic object description module, and adds the target haptic action node array to the haptic action node list of the target action description module of the MPEG interactivity description module in the scene description document. The haptic media accessor is the accessor configured to access the haptic rendering data of the haptic media file associated with the target action node when the target haptic action is executed, and the target action description module is the action description module corresponding to the target haptic action. Therefore, when the execution of the target haptic action in the 3D-scene-to-be-rendered is triggered, it may be determined based on the target haptic action node array and the target haptic object description module that the target action node needs to be rendered, and to-be-rendered data of the target action node is the haptic rendering data that is of the haptic media file and accessed through the haptic media accessor. Therefore, the above embodiments realize an association between a haptic action, a node, and haptic rendering data of a haptic media file, thus achieving support for the haptic media file in a scene description framework.

In some embodiments, the method for generating a scene description document further includes:

adding an action type syntax element (type) to the target action description module, and setting a value of the action type syntax element based on the action type of a target action.

As described in the above example, after the action type syntax element is added to the target action description module, and the value of the action type syntax element is set based on the action type of the target action, the target action description module may be as follows:

| | |
|---|---|
| n+01 | { |
| n+02 | “type”: “ACTION_HAPTIC”, |
| n+03 | “hapticActionNodes”:[ |
| n+04 | { |
| n+05 | “node”:0 |
| n+06 | “hapticObject”:0 |
| n+07 | }, |
| n+08 | { |
| n+09 | “node”:1 |
| n+10 | “hapticObject”:1 |
| n+11 | }, |
| n+12 | { |
| n+13 | “node”:2 |
| n+14 | } |
| n+15 | ] |
| n+16 | } |

In some embodiments, the method for generating a scene description document further includes: generating a corresponding target behavior array of a target behavior based on an index value of a trigger description module corresponding to a trigger associated with the target behavior and an index value of an action description module corresponding to an action associated with the target behavior, and adding the target behavior array to a behavior list (behaviors”: [ ]) of the MPEG interactivity description module (“MPEG_interactivity”: { }). The target behavior is any behavior in the 3D-scene-to-be-rendered.

In some embodiments, the generating a corresponding target behavior array of a target behavior based on an index value of a trigger description module corresponding to a trigger associated with the target behavior and an index value of an action description module corresponding to an action associated with the target behavior includes following steps 1 and 2:

Step 1: Add a trigger index syntax element (triggers) to the target behavior array, and set a value of the trigger index syntax element to the index value of the trigger description module corresponding to the trigger associated with the target behavior.

Step 2: Add an action index syntax element (actions) to the target behavior array, and set a value of the action index syntax element to the index value of the action description module corresponding to the action associated with the target behavior.

It should be noted that one behavior may be associated with at least one action.

For example, if the index value of the trigger description module corresponding to the trigger associated with the target behavior is 0, the target behavior is associated with two actions, and index values of action description modules corresponding to the two actions are respectively 1 and 2, the corresponding target behavior array of the target behavior may be as follows:

| | |
|---|---|
| n+1 | { |
| n+2 | “triggers”:0, |
| n+3 | “actions”:1,2 |
| n+4 | }, |

In some embodiments, the method for generating a scene description document further includes: generating, based on a type of a target trigger, a target trigger description module corresponding to the target trigger, and adding the target trigger description module to a trigger list (“triggers”: [ ]) of the MPEG interactivity description module (“MPEG_interactivity”: { }). The target trigger is any trigger in the 3D-scene-to-be-rendered.

In some embodiments, the generating, based on a type of a target trigger, a target trigger description module corresponding to the target trigger includes: adding a trigger type syntax element (type) to the target trigger description module, and setting a value of the trigger type syntax element based on the type of the target trigger.

As shown in Table 9 above, if the type of the target trigger is TRIGGER_COLLISION, the trigger type syntax element and its value are set to “type”: “TRIGGER_COLLISION”. If the type of the target trigger is TRIGGER PROXIMITY, the trigger type syntax element and its value are set to “type”: “TRIGGER_PROXIMITY”. If the type of the target trigger is TRIGGER USER INPUT, the trigger type syntax element and its value are set to “type”: “RIGGER_USER_INPUT”. If the type of the target trigger type is TRIGGER VISIBILITY, the trigger type syntax element and its value are set to “type”: “TRIGGER_VISIBILITY”.

For example, if the type of the target trigger is the TRIGGER COLLISION, the target trigger description module corresponding to the target trigger may be as follows:

| | |
|---|---|
| n+1 | { |
| n+2 | “type”:“TRIGGER_COLLISION” |
| n+3 | }, |

In some embodiments, the method for generating a scene description document further includes: generating, based on description information of the haptic media file, a target media description module corresponding to the haptic media file, and adding the target media description module to a media list (“media”) of the MPEG media description module (“MPEG_media”: { }) in the scene description document.

In some embodiments, the generating, based on description information of the haptic media file, a target media description module corresponding to the haptic media file includes at least one of following steps 31 to 35:

Step 31: Add a media name syntax element (name) to the target media description module, and set a value of the media name syntax element based on a name of the haptic media file.

For example, if the name of the haptic media file is “Hapticexample”, the media name syntax element (name) is added to the target media description module, and the media name syntax element and its value are set to “name”: “Hapticexample”.

Step 32: Add an autoplay syntax element (autoplay) to the target media description module, and set a value of the autoplay syntax element in accordance with a determination regarding whether the haptic media file needs to be automatically played.

For example, if the haptic media file needs to be automatically played, the syntax element “autoplay” is added to the target media description module, and the syntax element “autoplay” and its value are set to “autoplay”: true or “autoplay”: 1.

For another example, if the haptic media file does not need to be automatically played, the syntax element “autoplay” is added to the target media description module, and the syntax element “autoplay” and its value are set to “autoplay”: false or “autoplay”: 0.

Step 33: Add a loop syntax element (loop) to the target media description module, and set a value of the loop syntax element based on whether the haptic media file needs to be cyclically played.

For example, if the haptic media file needs to be cyclically played, the syntax element “loop” is added to the target media description module, and the syntax element “loop” and its value are set to “loop”: true or “autoplay”: 1.

For another example, if the haptic media file does not need to be cyclically played, the syntax element “loop” is added to the target media description module, and the syntax element “loop” and its value are set to “loop”: false or “autoplay”: 0.

Step 34: Add an alternative version list (“alternatives”: [ ]) to the target media description module.

Step 35: Generate, based on description information of each alternative version of the haptic media file, an alternative version description module corresponding to each alternative version of the haptic media file, and add the alternative version description module corresponding to each alternative version of the haptic media file to the alternative version list (“alternatives”: [ ]).

In some embodiments, the generating, based on description information of each alternative version of the haptic media file, an alternative version description module corresponding to each alternative version of the haptic media file in the above-mentioned step 35 includes at least one of following steps 351 to 355:

Step 351: Add a media type syntax element (mimeType) to a target alternative version description module corresponding to a target alternative version of the haptic media file, and set a value of the media type syntax element based on data included in the target alternative version. The target alternative version is any alternative version of the haptic media file. The alternative version description module may be generated for each alternative version of the haptic media file according to the embodiments of the present disclosure.

In some embodiments, the setting a value of the media type syntax element based on data included in the target alternative version includes: when the haptic media file includes audio data and/or video data, setting the value of the media type syntax element to a first preset value; or

when the haptic media file does not include audio data or video data, setting the value of the media type syntax element to a second preset value.

For example, the first preset value may be “video/mp4”, and the second preset value may be “haptic/mp4”.

Step 352: Add a URI syntax element (uri) to the target alternative version description module, and set a value of the URI syntax element based on a URI of the target alternative version.

For example, if the URI of the target alternative version of the haptic media file is “http://www.Hapticexample.mp4”, the URI syntax element (uri) is added to the target alternative version description module, and the URI syntax element (uri) and its value are set to “uri”: “http://www.Hapticexample.mp4”.

Step 353: Add a track array (tracks [ ]) to the target alternative version description module.

Step 354: Add a first track index syntax element (track) to the track array (tracks [ ]), and set a value of the first track index syntax element to an index value of each bitstream track of the target alternative version.

That is, when encoded haptic media is referenced by the scene description document as an item in the MPEG_media.alternative.tracks, and the referenced item complies with a provision on the track in an ISOBMFF in an ISO/IEC 23090-32 standard, for a haptic media file encapsulated into a single track, a track referenced in the MPEG media is a single track into which the haptic media is encapsulated. For a haptic media file encapsulated into a plurality of tracks, a plurality of tracks into which the haptic media is encapsulated are referenced in the MPEG media. For example, a non-zero value is defined in advance in TrackHeaderBox of configuration information alternate_group in an encapsulated file to indicate that the haptic media is encapsulated into a plurality of MIHS tracks, which are also indexed by the MPEG media.

Step 355: Add a codec parameter syntax element (codecs) to the track array (tracks [ ]), and set a value of the codec parameter syntax element based on an encoding parameter of data in each bitstream track of the target alternative version and a provision in a standard for carriage of haptics data in the ISO/IEC 23090-32 standard.

A codec parameter of media included in the track array (tracks) is defined in IETF RFC 6381. When the track array includes different types of codecs (for example, AdaptationSet includes representations for different codecs), the codec parameter syntax element may be represented by a list of codec values separated by a comma.

When media data is haptic data, a relevant detailed provision in the standard for carriage of haptics data in the ISO/IEC 23090-32 standard should be followed. For example, when the haptic data is encapsulated by using an ISMBOFF, a first group of elements in the codec parameter syntax element represents a code of a codec in an ISO/IEC 23090-31 standard. A format of the value of the codec parameter syntax element is ‘codec=mih1.00’, where “mih1” represents a type of data format description for encapsulating the haptic data in the ISOBMFF. This value is not unique and may be replaced by another sample format name that complies with ISOBMFF encapsulation. “00” represents an object type indication value defined on an “Object Type” page at a website of the MP4 registration authority.

For example, if the name of the haptic media file is Hapticexample, the haptic media file needs to be automatically and cyclically played, the haptic media file includes the audio data and/or the video data, an access address of the haptic media file is www.example.com/Hapticexample.mp4, the haptic media file is a single-track encapsulated file, and the index value of the bitstream track is 1, the target media description module may be as follows:

| | |
|---|---|
| n+01 | { |
| n+02 | “name”: “Hapticexample”, |
| n+03 | “autoplay”: true, |
| n+04 | “loop”: true, |
| n+05 | “alternatives”: [ |
| n+06 | { |
| n+07 | “mimeType”: “video /mp4”, |
| n+08 | “uri”:”http://www.example.com/Hapticexample.mp4”, |
| n+09 | “tracks”: [ |
| n+10 | { |
| n+11 | “track”: “trackIndex=1”, |
| n+12 | “codecs”: “mih1.oo” |
| n+13 | } |

In some embodiments, the method for generating a scene description document further includes:

generating, based on description information of the 3D-scene-to-be-rendered, a target scene description module corresponding to the 3D-scene-to-be-rendered, and adding the target scene description module to a scene list (“scenes”: [ ]) of the scene description document.

In some embodiments, the generating, based on description information of the 3D-scene-to-be-rendered, a target scene description module corresponding to the 3D-scene-to-be-rendered includes: adding a node index list (“nodes”: [ ]) to the target scene description module, and adding an index value of a node description module corresponding to each top-level node in the 3D-scene-to-be-rendered to the node index list.

It should be emphasized that in the embodiments of the present disclosure, only the index value of the node description module corresponding to the top-level node in the 3D-scene-to-be-rendered, instead of index values of node description modules corresponding to all nodes (excluding an index value of a node description module corresponding to a child node), is added to the node index list.

For example, if the 3D-scene-to-be-rendered includes three top-level nodes, and index values of node description modules corresponding to the three top-level nodes are 0, 1, and 2 respectively, the target scene description module may be as follows:

| | |
|---|---|
| n+1 | { |
| n+2 | “nodes”: [ |
| n+3 | 0,1,2 |
| n+4 | ] |
| n+5 | } |
| n+6 | ] |

In some embodiments, the method for generating a scene description document further includes: generating, based on description information of a target node, a target node description module corresponding to the target node, and adding the target node description module to a node list (“nodes”: [ ]) of the scene description document. The target node is any node in the 3D-scene-to-be-rendered.

In some embodiments, the generating, based on description information of a target node, a target node description module corresponding to the target node includes at least one of following steps 41 to 44:

Step 41: Add a node name syntax element (name) to the target node description module, and set a value of the node name syntax element based on a name of the target node.

For example, if the name of the target node is “Haptic_node”, the node name syntax element (name) is added to the target media description module, and the node name syntax element in the target node description module and its value are set to “name”: “Haptic_node”.

Step 42: Add a child node index list (“children”: [ ]) to the target node description module, and add an index value of a node description module corresponding to each child node mounted to the target node to the child node index list.

For example, if two child nodes are mounted to the target node, an index value of a node description module corresponding to one child node is 1, and an index value of a node description module corresponding to the other child node is 2, the child node index list of the target node description module may be as follows:

| | |
|---|---|
| n+1 | “children”:[ |
| n+2 | 1,2 |
| n+3 | ] |

Step 43: Add a mesh index syntax element (mesh) to the target node description module, and set a value of the mesh index syntax element (mesh) to an index value of a mesh description module corresponding to a 3D mesh mounted to the target node.

For example, if one 3D mesh is mounted to the target node, and an index value of a mesh description module corresponding to the one 3D mesh is 0, the mesh index syntax element (mesh) is added to the target media description module, and the mesh index syntax element in the target node description module and its value are set to “mesh”: 0.

Step 44: Add a position offset syntax element (translation) to the target node description module, and set a value of the position offset syntax element based on a spatial position offset of the target node relative to a parent node of the target node.

It should be clarified that a spatial position offset of a node relative to a parent node of the node is directly obtained based on a value of a position offset syntax element in a node description module. The spatial position offset does not necessarily mean a spatial position offset of the node relative to a node representing a target digital human. The spatial position offset of the node relative to the node representing the target digital human is a sum of spatial offsets of all nodes on a path from the node to the node representing the target digital human.

For example, a node A is a child node of the node representing the target digital human, a node B is a child node of the node A, a position offset syntax element in a node description module corresponding to the node A and its value are “translation”: [0.0, 10.0, 25.0], and a position offset syntax element in a node description module corresponding to the node B and its value are “translation”: [0.0, 10.0, 20.0]. Therefore, it may be first obtained that an offset of the node A relative to the node representing the target digital human is [0.0, 10.0, 25.0] and an offset of the node B relative to the node A is [0.0, 00.0, 20.0]. Then, the position offsets are superimposed to obtain an offset of the node B relative to the node representing the target digital human, namely [0.0, 10.0, 45.0].

For example, if the name of the target node is “Hapticexample_mesh”, the target node includes two child nodes, index values of node description modules corresponding to the two child nodes are 1 and 2 respectively, the index value of the mesh description module corresponding to the 3D mesh mounted to the target node is 0, and the spatial position offset of the target node relative to the parent node of the target node is [0.0, 10.0, 25.0], the node description module generated based on the description information of the target node may be as follows:

| | |
|---|---|
| n+0 | { |
| n+1 | “name”: “Hapticexample_mesh”, |
| n+2 | “children”:[ |
| n+3 | 1,2 |
| n+4 | ], |
| n+5 | “mesh”: 0, |
| n+6 | “translation”: [ 0.0, 10.0, 25.0 ] |
| n+7 | }, |

In some embodiments, the method for generating a scene description document further includes: generating, based on description information of a target 3D mesh, a target mesh description module corresponding to the target 3D mesh, and adding the target mesh description module to a mesh list (“meshes”: [ ]) of the scene description document. The target 3D mesh is any 3D mesh in the 3D-scene-to-be-rendered.

In some embodiments, the generating, based on description information of a target 3D mesh, a target mesh description module corresponding to the target 3D mesh includes at least one of following steps 51 to 56:

Step 51: Add a mesh name syntax element (name) to the target mesh description module, and set a value of the mesh name syntax element based on a name of the target 3D mesh.

For example, if the name of the target 3D mesh is “example_mesh”, the mesh name syntax element is added to the target mesh description module, and the mesh name syntax element and its value are set to “name”: “example_mesh”.

Step 52: Add a texture coordinate syntax element (TEXCOORD_n) to an attribute (attributes) of a primitive (primitives) of the target mesh description module, and set the texture coordinate syntax element to an index value of an accessor description module corresponding to an accessor for accessing a texture coordinate of the target 3D mesh.

Step 53: Add a mode syntax element (mode) to the primitive of the target mesh description module, and set a value of the mode syntax element based on a topology type of the target 3D mesh.

Step 54: Add an MPEG haptic material description module (“MPEG_material_Haptic”: { }) to the primitive (primitives) of the target mesh description module, add a haptic material array index syntax element (index) to the MPEG haptic material description module (“MPEG_material_Haptic”: { }), and set a value of the haptic material array index syntax element to an index value of a haptic material array associated with the target 3D mesh.

For example, if the name of the target 3D mesh is Hapticexample_mesh, a topology of the target 3D mesh is scattered, and an index value of a haptic material attribute array associated with the target 3D mesh is 2, the target mesh description module corresponding to the target 3D mesh may be as follows:

| | |
|---|---|
| n+01 | { |
| n+02 | “name”: “Hapticexample_mesh”, |
| n+03 | “primitives”:[ |
| n+04 | { |
| n+05 | “attributes”:{ |
| n+06 | “TEXCOORD_2”:3 |
| n+07 | }, |
| n+08 | “mode”: 0 |
| n+09 | “extensions”:{ |
| n+10 | “MPEG_material_Haptic”: |
| n+11 | { |
| n+12 | “index”:2 |
| n+13 | } |
| n+14 | } |
| n+15 | } |
| n+16 | ] |
| n+17 | } |

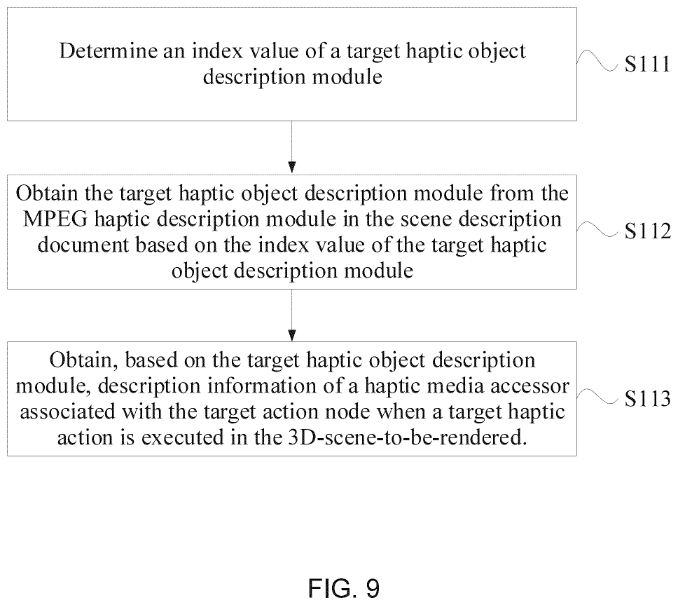

Some embodiments of the present disclosure further provide a method for parsing a scene description document. Referring to FIG. 9, the method for parsing a scene description document includes following steps S111 to S113:

S111: Determine an index value of a target haptic object description module.

The determine the index value of the target haptic object description module includes: obtain a target haptic action node array from a haptic action node list (“hapticActionNodes”: [ ]) of a target action description module of an MPEG interactivity description module (“MPEG_interactivity”: { }) in a scene description document of a 3D-scene-to-be-rendered; determine, according to the target haptic action node array, an index value of a target haptic object description module corresponding to a haptic object associated with a target action node.

The target action description module may be any action description module of the MPEG interactivity description module, and the target haptic action node array may be any haptic action node array in the haptic action node list of the target action description module. For example, the target action description module may be as follows:

| | |
|---|---|
| n+01 | { |
| n+02 | “type”:“ACTION_SET_HAPTIC”, |
| n+03 | “hapticActionNodes”:[ |
| n+04 | { |
| n+05 | “node”:0 |
| n+06 | “hapticObject”:0 |
| n+07 | }, |
| n+08 | { |
| n+09 | “node”:1 |
| n+10 | “hapticObject”:1 |
| n+11 | }, |
| n+12 | { |
| n+13 | “node”:2 |
| n+14 | } |
| n+15 | ] |
| n+16 | }, |

It should be noted that although a third haptic action node array (lines n+12 to n+14) in the haptic action node list (“hapticActionNodes”: [ ]) of the target action description module does not include a haptic object syntax element (hapticObject), a node (corresponding to a node description module with an index value of 2) declared in the third haptic action node array also needs to be associated with haptic data. The haptic data associated with the node will be associated with relevant haptic data in a mesh description module by using an MPEG haptic material (MPEG_haptic_material).

For example, it is assumed that the target haptic action node array is as follows:

| | |
|---|---|
| n+01 | { |
| n+02 | “node”:0 |
| n+03 | “hapticObject”:0 |
| n+04 | }, |

Therefore, a node corresponding to a node description module with an index value of 0 (a first node description module in a node list) is the target action node, and the index value of the target haptic object description module corresponding to the haptic object associated with the target action node is 0 (a first haptic object description module in an MPEG haptic description module).

S112: Obtain the target haptic object description module from the MPEG haptic description module (“MPEG_haptic”: { }) in the scene description document based on the index value of the target haptic object description module.

In some embodiments, the determining, based on the target haptic action node array, an index value of a target haptic object description module corresponding to a haptic object associated with a target action node includes: obtaining a value of a haptic object index syntax element (hapticObject) in the target haptic action node array, and determining the index value of the target haptic object description module based on the value of the haptic object index syntax element.

As described in the above example, the haptic object index syntax element in the target haptic action node array and its value are “hapticObject”: 0. Therefore, it may be determined that the index value of the target haptic object description module is 0, and the first haptic object description module may be obtained as the target haptic object description module from the MPEG haptic description module (“MPEG_haptic”: { }) in the scene description document.

S113: Obtain, based on the target haptic object description module, description information of a haptic media accessor associated with the target action node when a target haptic action is executed in the 3D-scene-to-be-rendered.

The target haptic action is a haptic action corresponding to the target action description module. The haptic media accessor is an accessor configured to access haptic rendering data of a haptic media file declared in an MPEG media description module (“MPEG_media”: { }) associated with the target action node when the target haptic action is executed.

It should be noted that there may be at least one haptic media accessor associated with an action node.

In some embodiments, the obtaining, based on the target haptic object description module, description information of a haptic media accessor associated with the target action node when a target haptic action is executed in the 3D-scene-to-be-rendered in the above-mentioned step S113 includes following steps 1131 to 1133:

Step 1131: Obtain a value of an accessor index syntax element (accessor) in the target haptic object description module.

Step 1132: Obtain an accessor description module corresponding to the haptic media accessor from an accessor list (“accessors”: [ ]) of the scene description document based on the value of the accessor index syntax element.

Step 1133: Obtain the description information of the haptic media accessor based on the accessor description module corresponding to the haptic media accessor.

For example, it is assumed that the target haptic object description module is as follows:

| | |
|---|---|
| n+1 | “hapticObject”:[ |
| n+2 | { |
| n+3 | “accessor”:1,4 |
| n+4 | } |
| n+5 | ], |

Therefore, the above-mentioned steps 1141 to 1143 include: obtaining second and fifth accessor description modules from the accessor list (“accessors”: [ ]) of the scene description document based on values (1 and 4) of the accessor index syntax element (accessor), and obtaining the description information of the haptic media accessor based on the second and fifth accessor description modules.

The method for parsing a scene description document provided in the embodiments of the present disclosure may obtain the target haptic action node array from the haptic action node list of the target action description module of the MPEG interactivity description module in the scene description document of the 3D-scene-to-be-rendered, determine, based on the target haptic action node array, the index value of the target haptic object description module corresponding to the haptic object associated with the target action node, obtain the target haptic object description module from the MPEG haptic description module in the scene description document based on the index value of the target haptic object description module, and obtain, based on the target haptic object description module, the description information of the accessor that is associated with the target action node and configured to access the haptic rendering data of the haptic media file declared in the MPEG media description module when the haptic action corresponding to the target action description module is executed in the 3D-scene-to-be-rendered. The method for parsing a scene description document provided in the embodiments of the present disclosure may obtain description information of an accessor that is associated with an action node and configured to access haptic rendering data of a haptic media file when a haptic action is executed in the 3D-scene-to-be-rendered, realizing an association between a haptic action, a node, and haptic rendering data of a haptic media file. Therefore, the above embodiments realize support for the haptic media file in a scene description framework.

In some embodiments, the method for parsing a scene description document further includes: obtaining a value of an action type syntax element (type) in the target action description module, and obtaining an action type of a target action based on the value of the action type syntax element.

For example, when the action type syntax element and its value are “type”: “ACTION HAPTIC”, it is determined that the action type of the target action is to obtain a haptic feedback on a group of nodes.

In some embodiments, the method for parsing a scene description document further includes: obtaining a target behavior array from a behavior list (behaviors”: [ ]) of the MPEG interactivity description module (“MPEG_interactivity”: { }), and obtaining, based on the target behavior array, description information of a target behavior corresponding to the target behavior array. The target behavior array is any behavior array in the behavior list (behaviors”: [ ]).

For example, the target behavior array may be as follows:

| | |
|---|---|
| n+1 | { |
| n+2 | “triggers”:0, |
| n+3 | “actions”:0,1 |
| n+4 | }, |

In some embodiments, the obtaining, based on the target behavior array, description information of a target behavior corresponding to the target behavior array includes at least one of following steps a1 and a2:

Step a1: Determine, based on a value of a trigger index syntax element (triggers) in the target behavior array, an index value of a trigger description module corresponding to a trigger of the target behavior.

As described in the above example, the value of the trigger index syntax element (triggers) in the target behavior array is 0. Therefore, it may be determined that the index value of the trigger description module corresponding to the trigger of the target behavior is 0.

Step a2: Determine, based on a value of an action index syntax element (actions) in the target behavior array, an index value of an action description module corresponding to an action of the target behavior.

As described in the above example, values of the trigger index syntax element (triggers) in the target behavior array are 0 and 1. Therefore, it may be determined that the target behavior includes two actions, and the two actions respectively correspond to an action description module with an index value of 0 and an action description module with an index value of 1.

In some embodiments, the method for parsing a scene description document further includes: obtaining a target trigger description module from a trigger list (“triggers”: [ ]) of the MPEG interactivity description module (“MPEG_interactivity”: { }), and obtaining, based on the target trigger description module, description information of a target trigger corresponding to the target trigger description module.

The target trigger description module is any trigger description module in the trigger list.

For example, the target trigger description module may be as follows:

| | |
|---|---|
| n+1 | { |
| n+2 | “type”:“TRIGGER_COLLISION” |
| n+3 | }, |

In some embodiments, the obtaining, based on the target trigger description module, description information of a target trigger corresponding to the target trigger description module includes: obtaining a type of the target trigger based on a value of a trigger type syntax element (type) in the target trigger description module.

For example, when the trigger type syntax element in the target trigger description module and its value are “type”: “TRIGGER_COLLISION”, it may be determined that the type of the target trigger is TRIGGER COLLISION.

For another example, when the trigger type syntax element in the target trigger description module and its value are “type”: “TRIGGER_VISIBILITY”, it may be determined that the type of the target trigger is TRIGGER VISIBILITY.

In some embodiments, the method for parsing a scene description document further includes: obtaining a target media description module corresponding to the haptic media file from a media list (“media”: [ ]) of the MPEG media description module (“MPEG_media”: { }) in the scene description document, and obtaining description information of the haptic media file based on the target media description module.

In some embodiments, the obtaining description information of the haptic media file based on the target media description module includes at least one of following steps b1 to b4:

Step b1: Obtain a name of the haptic media file based on a value of a media name syntax element (name) in the target media description module.

For example, if the media name syntax element in the target media description module and its value are “name”: “Hapticexample”, it may be determined that the name of the haptic media file is Hapticexample.

Step b2: Determine, based on a value of an autoplay syntax element (autoplay) in the target media description module, whether the haptic media file needs to be automatically played.

In some embodiments, the determining, based on a value of an autoplay syntax element (autoplay) in the target media description module, whether the haptic media file needs to be automatically played includes: if the autoplay syntax element (autoplay) in the target media description module and its value are “autoplay”: true or “autoplay”: 1, determining that the haptic media file needs to be automatically played; or if the autoplay syntax element (autoplay) in the target media description module and its value are “autoplay”: false or “autoplay”: 0, determining that the haptic media file does not need to be automatically played.

Step b3: Determine, based on a value of a loop syntax element (loop) in the target media description module, whether the haptic media file needs to be cyclically played.

In some embodiments, the determining, based on a value of a loop syntax element (loop) in the target media description module, whether the haptic media file needs to be cyclically played includes: if the loop syntax element (loop) in the target media description module and its value are “loop”: true or “loop”: 1, determining that the haptic media file needs to be cyclically played; or if the loop syntax element (loop) in the target media description module and its value are “loop”: false or “loop”: 0, determining that the haptic media file does not need to be cyclically played.

Step b4: Obtain description information of each alternative version of the haptic media file based on each alternative version description module in an alternative version list (“alternatives”: [ ]) in the target media description module.

In some embodiments, the obtaining description information of each alternative version of the haptic media file based on each alternative version description module in an alternative version list of the target media description module in the above-mentioned step b4 may include at least one of following steps b41 to b44:

Step b41: Obtain, based on a value of a media type syntax element (mimeType) in a target alternative version description module, data included in a target alternative version corresponding to the target alternative version description module.

The target alternative version description module is any alternative version description module in the alternative version list.

In some embodiments, the obtaining, based on a value of a media type syntax element (mimeType) in a target alternative version description module, data included in a target alternative version corresponding to the target alternative version description module includes: in accordance with a determination that the value of the media type syntax element is a first preset value, determining that the target alternative version includes haptic data and audio and/or video data; alternatively, in accordance with a determination that the value of the media type syntax element is a second preset value, determining that the target alternative version includes haptic data.

For example, the first preset value may be video/mp4, and the second preset value may be haptic/mp4.

Step b42: Obtain a URI of the target alternative version based on a value of a URI syntax element (uri) in the target alternative version description module.

For example, if a URI syntax element (uri) in an alternative version description module in the alternative version list (“alternatives”: [ ]) of the target media description module and its value are “uri”: “http://www.example.com/Hapticexample.mp4”, it may be determined that a URI (access address) of an alternative version of a haptic media file corresponding to the alternative version description module is “http://www.example.com/Hapticexample.mp4”.

Step b43: Obtain an index value of each bitstream track of the target alternative version based on a value of a first track index syntax element (track) in a track array (“tracks”: [ ]) of the target alternative version description module.

Step b44: Obtain a decoding parameter of a bitstream of the target alternative version based on a value of a codec parameter syntax element (codecs) in the track array (“tracks”: [ ]) of the target alternative version description module and a provision in a standard for carriage of haptics data in an ISO/IEC 23090-32 standard.

In some embodiments, the method for parsing a scene description document provided in the embodiments of the present disclosure further includes: obtaining a target scene description module corresponding to the 3D-scene-to-be-rendered from a scene list (“scenes”: [ ]) of the scene description document, and obtaining description information of the 3D-scene-to-be-rendered based on the target scene description module.

In some embodiments, the obtaining description information of the 3D-scene-to-be-rendered based on the target scene description module includes:

determining, based on an index value declared in a node index list (“nodes”: [ ]) of the target scene description module, an index value of a node description module corresponding to each top-level node in the 3D-scene-to-be-rendered.

For example, if the node index list of the target scene description module and its declared index value are “nodes”: [0], it may be determined that the 3D-scene-to-be-rendered includes only one top-level node, and a node description module corresponding to the one top-level node is the first node description module in the node list of the scene description document.

For another example, if the node index list of the target scene description module and its declared index value are “nodes”: [0,4], it may be determined that the 3D-scene-to-be-rendered includes two top-level nodes, and node description modules corresponding to the two top-level nodes are respectively the first node description module and a fifth node description module in the node list of the scene description document.

In some embodiments, the method for parsing a scene description document provided in the embodiments of the present disclosure further includes: obtaining a target node description module from the node list (“nodes”: [ ]) of the scene description document, and obtaining, based on the target node description module, description information of a target node corresponding to the target node description module.

The target node description module is any node description module in the node list.

In some embodiments, the obtaining, based on the target node description module, description information of a target node corresponding to the target node description module includes at least one of following steps c1 to c4:

Step c1: Obtain a name of the target node based on a value of a node name syntax element in the target node description module.

For example, if the node name syntax element in the target node description module and its value are “name”: “Haptic_node1”, it may be obtained based on the value of the node name syntax element in the target node description module that the name of the target node is Haptic_node1.

Step c2: Obtain, based on an index value declared in a child node index list (“children”: [ ]) of the target node description module, an index value of a node description module corresponding to each child node mounted to the target node.

For example, if the child node index list of the target node description module and its declared index value are “children”: [1,2], it may be determined based on the index value declared in the child node index list of the target node description module that two child nodes are mounted to the target node, and the two child nodes mounted to the target node respectively correspond to a second node description module and a third node description module in the node list of the scene description document.

Step c3: Obtain, based on an index value declared in a mesh index syntax element (mesh) in the target node description module, an index value of a mesh description module corresponding to each 3D mesh mounted to the target node.

For example, if the mesh index syntax element in the target node description module and its value are “mesh”: 0, it may be determined based on the index value declared in the mesh index syntax element in the target node description module that the 3D mesh mounted to the target node is a 3D mesh corresponding to a first mesh description module in a mesh list (“meshes”: [ ]) of the scene description document.

Step c4: Obtain a spatial position offset of the target node relative to a parent node of the target node based on a value of a position offset syntax element (translation) in the target node description module.

For example, if the position offset syntax element in the target node description module and its value are “translation”: [0.0, 0.0, 20.0], it may be obtained based on the value of the position offset syntax element in the target node description module that the spatial position offset of the target node relative to the parent node of the target node is [0.0, 0.0, 20.0].

It should be noted that the spatial position offset of the target node relative to the parent node of the target node is directly obtained based on the position offset syntax element in the target node description module. If the parent node of the target node is not a root node, the spatial position offset may not be an offset of the target node relative to the root node. The offset of the target node relative to the root node is a sum of spatial offsets of all nodes on a path from the target node to the root node.

For example, a node A is a child node of the root node, a node B is a child node of the node A, a position offset syntax element in a node description module corresponding to the node A and its value are “translation”: [0.0, 10.0, 25.0], and a position offset syntax element in a node description module corresponding to the node B and its value are “translation”: [0.0, 10.0, 20.0], it may be first obtained that an offset of the node A relative to the target node is [0.0, 10.0, 25.0] and an offset of the node B relative to the node A is [0.0, 00.0, 20.0]. Then, the position offsets are superimposed to obtain an offset of the node B relative to the root node, namely [0.0, 10.0, 45.0].

In some embodiments, the method for parsing a scene description document further includes:

obtaining a target mesh description module from the mesh list (“nodes”: [ ]) in the scene description document, and obtaining, based on the target mesh description module, description information of a target 3D mesh corresponding to the target mesh description module. The target mesh description module is any mesh description module in the mesh list.

In some embodiments, the obtaining, based on the target mesh description module, description information of a target 3D mesh corresponding to the target mesh description module includes at least one of following steps d1 to d5:

Step d1: Obtain a name of the target 3D mesh based on a value of a mesh name syntax element (name) in the target mesh description module.

For example, if a mesh name syntax element in a mesh description module in the scene description document and its value are “name”: “Haptic_mesh1”, it may be obtained based on the value of the mesh name syntax element in the mesh description module that a name of a 3D mesh corresponding to the mesh description module is Haptic_mesh1.

Step d2: Obtain, based on a value of a texture coordinate syntax element (TEXCOORD_n) in an attribute (attributes) of a primitive (primitives) of the target mesh description module, an index value of an accessor description module corresponding to an accessor for accessing a texture coordinate of the target 3D mesh.

For example, if a texture coordinate syntax element in an attribute of a primitive of a mesh description module in the scene description document and its value are “TEXCOORD_0”: 1, it may be determined that an accessor for accessing a texture coordinate of a 3D mesh corresponding to the mesh description module is an accessor corresponding to the second accessor description module in the accessor list of the scene description document.

Step d3: Obtain a topology type of the target 3D mesh based on a value of a mode syntax element (mode) in the primitive (primitives) of the target mesh description module.

For example, if a mode syntax element in a primitive of a mesh description module in the scene description document and its value are “mode”: 4, it may be obtained based on the value of the mode name syntax element in the primitive of the mesh description module that a topology type of a 3D mesh corresponding to the mesh description module is a triangular patch.

Step d4: Obtain, based on a value of a haptic material array index syntax element (index) in an MPEG haptic material description module (“MPEG_material_Haptic”: { }) in the primitive of the target mesh description module, description information of a haptic material attribute carried by the target 3D mesh.

In some embodiments, the obtaining, based on a value of a haptic material array index syntax element (index) in an MPEG haptic material description module in the primitive of the target mesh description module, description information of a haptic material attribute carried by the target 3D mesh in the above-mentioned step d4 includes at least one of following steps d41 to d43:

Step d41: Obtain a haptic material array associated with the target 3D mesh from a haptic material list (“MPEG_material_Haptic”: [ ]) of the scene description document based on the value of the haptic material array index syntax element (index).

For example, if the haptic material array index syntax element and its value are “index”: 0, a first haptic material array in the haptic material list of the scene description document is obtained as the haptic material array associated with the target 3D mesh.

For example, the haptic material array associated with the target 3D mesh may be as follows:

| | |
|---|---|
| n+01 | { |
| n+02 | “stiffness”:{ |
| n+03 | “texture”: { |
| n+04 | “index”:0, |
| n+05 | “texCoord”:0 |
| n+06 | }, |
| n+07 | “type”:Low_resolution |
| n+08 | }, |
| n+09 | “temperature”:{ |
| n+10 | “texture”: { |
| n+11 | “index”:1, |
| n+12 | “texCoord”:0 |
| n+13 | }, |
| n+14 | “type”:Reference |
| n+15 | }, |
| n+16 | “vibration”:{ |
| n+17 | “texture”: { |
| n+18 | “index”:2, |
| n+19 | “texCoord”:0 |
| n+20 | }, |
| n+21 | “type”:Reference |
| n+22 | } |
| n+23 | } |

Step d42: Obtain a haptic material attribute description module corresponding to the haptic material attribute carried by the target 3D mesh from the haptic material array associated with the target 3D mesh.

As described in the above example, haptic material attribute description modules corresponding to stiffness, temperature, and vibration that are carried by the target 3D mesh may be obtained from the haptic material array associated with the target 3D mesh. The haptic material attribute description module corresponding to the stiffness is content at lines n+02 to n+08, the haptic material attribute description module corresponding to the temperature is content at lines n+09 to n+15, and the haptic material attribute description module corresponding to the vibration is content at lines n+16 to n+22.

Step d43: Obtain, based on a haptic material attribute description module corresponding to each haptic material attribute carried by the target 3D mesh, the description information of the haptic material attribute carried by the target 3D mesh.

In some embodiments, the obtaining, based on a haptic material attribute description module corresponding to each haptic material attribute carried by the target 3D mesh, the description information of the haptic material attribute carried by the target 3D mesh in above-mentioned step d43 includes at least one of following steps d431 to d433:

Step d431: Obtain, based on a value of a texture index syntax element (index) in a texture array (“texture”: { }) of a target haptic material attribute description module, texture description information of a texture associated with a target haptic material corresponding to the target haptic material attribute description module.

The target haptic material attribute description module is any haptic material attribute description module in the haptic material array associated with the target 3D mesh.

In some embodiments, the obtaining, based on a value of a texture index syntax element in a texture array of a target haptic material attribute description module, texture description information of a texture associated with a target haptic material corresponding to the target haptic material attribute description module in the above-mentioned step d431 includes at least one of following steps d4311 and d4312:

Step d4311: Obtain a target texture description module from a texture list (“textures”: [ ]) of the scene description document based on the value of the texture index syntax element.

For example, if the texture index syntax element and its value are “index”: 2, a third texture description module is obtained from the texture list (“textures”: [ ]) of the scene description document as the target texture description module.

Step d4312: Obtain, based on the target texture description module, the texture description information of the texture associated with the target haptic material.

In some embodiments, the obtaining, based on the target texture description module, the texture description information of the texture associated with the target haptic material in the above-mentioned step d4312 includes at least one of following steps e and f:

Step e: Obtain description information of a sampler of the target haptic material based on a value of a sampler index syntax element (sampler) in the target texture description module.

In some embodiments, the obtaining description information of a sampler of the target haptic material based on a value of a sampler index syntax element in the target texture description module in the above-mentioned step e includes following steps e1 and e2:

Step e1: Obtain a sampler description module corresponding to the sampler of the target haptic material from a sampler list (“samplers”: [ ]) of the scene description document based on the value of the sampler index syntax element (sampler) in the target texture description module.

For example, the sampler description module corresponding to the sampler of the target haptic material may be as follows:

| | |
|---|---|
| 201 | {“magFilter”: 9729, |
| 202 | “minFilter”: 9987, |
| 203 | “wrapS”: 33648, |
| 204 | “wrapT”: 33648} |
| 205 | ] |

Step e2: Obtain the description information of the sampler of the target haptic material based on the sampler description module corresponding to the sampler of the target haptic material.

As described in the above example, the description information that is of the sampler of the target haptic material and may be obtained based on the sampler description module corresponding to the sampler of the target haptic material includes: a nearest point mode is used to enlarge a texture map, a Linear-mipmap-linear mode is used to reduce the texture map, a texture wrapping method in a horizontal direction is 33648, and a texture wrapping method in a vertical direction is 33648.

Step f: Obtain description information of a texture resource of the target haptic material based on a value of a texture resource index syntax element (source) in the target texture description module.

In some embodiments, the obtaining description information of a texture resource of the target haptic material based on a value of a texture resource index syntax element in the target texture description module in the above f includes following steps f1 and f2:

Step f1: Obtain a texture resource description module corresponding to the texture resource of the target haptic material from a texture resource list (“images”: [ ]) of the scene description document based on the value of the texture resource index syntax element (source) in the target texture description module.

For example, the texture resource description module corresponding to the texture resource of the target haptic material may be as follows:

| | |
|---|---|
| n+1 | { |
| n+2 | “uri”: “stiffnessTexture.png” |
| n+3 | } |

Step f2: Obtain the description information of the texture resource of the target haptic material based on the texture resource description module corresponding to the texture resource of the target haptic material.

As described in the above example, based on a value of a URI syntax element (uri) in the texture resource description module corresponding to the texture resource of the target haptic material, it may be obtained that an access address of the texture resource of the target haptic material is stiffnessTexture.png.

Step d432: Obtain, based on a value of a texture coordinate index syntax element (texCoord) in the texture array of the target haptic material attribute description module, an index value of a texture coordinate syntax element (TEXCOORD_n) associated with the target haptic material.

Step d433: Obtain a type of a target haptic material attribute based on a value of a haptic material type syntax element (type) in the texture array of the target haptic material attribute description module.

As described in the above embodiments, it may be determined based on “type”: Low_resolution at line n+07 that a type of the stiffness is Low_resolution, it may be determined based on “type”: Reference at line n+14 that a type of the temperature is Reference, and it may be determined based on “type”: Reference at line n+21 that a type of the vibration is the Reference.

In some embodiments, the method for parsing a scene description document further includes: obtaining a target accessor description module from the accessor list (“accessors”: [ ]) of the scene description document, and obtaining, based on the target accessor description module, description information of a target accessor corresponding to the target accessor description module. The target accessor description module is any accessor description module in the accessor list (“accessors”: [ ]) of the scene description document.

In some embodiments, the obtaining, based on the target accessor description module, description information of a target accessor corresponding to the target accessor description module includes at least one of following steps g1 to g8:

Step g1: Obtain, based on a value of a data type syntax element (componentType) in the target accessor description module, a data type of data accessed by the target accessor.

For example, if a data type syntax element in an accessor description module and its value are “componentType”: 5126, it may be determined that a data type of data accessed by an accessor corresponding to the accessor description module is a 32-bit floating-point number (float).

Step g2: Determine a type of the target accessor based on a value of an accessor type syntax element (type) in the target accessor description module.

For example, if an accessor type syntax element in an accessor description module and its value are “type”: “VEC3”, it may be determined that a type of an accessor corresponding to the accessor description module is a 3D vector.

Step g3: Determine, based on a value of a data count syntax element (count) in the target accessor description module, a count of the data accessed by the target accessor.

For example, if a data count syntax element in an accessor description module and its value are “count”: 1828, it may be determined that 1828 pieces of data are accessed by an accessor corresponding to the accessor description module.

Step g4: Determine, based on a value of a first buffer view index syntax element (bufferView) in the target accessor description module, an index value of a buffer view description module corresponding to a buffer view for caching the data accessed by the target accessor.

For example, if a first buffer view index syntax element in an accessor description module and its value are “bufferView”: 1, it may be determined that data accessed by an accessor corresponding to the accessor description module is cached in a buffer view corresponding to a second buffer view description module in a buffer view list (“buffer Views”: [ ]).

Step g5: Determine, based on whether the target accessor description module includes an MPEG time-varying accessor (MPEG_accessor_timed), whether the target accessor is a time-varying accessor reconstructed based on an MPEG extension.

In some embodiments, the determining, based on whether the target accessor description module includes an MPEG time-varying accessor (“MPEG_accessor_timed”: { }), whether the target accessor is a time-varying accessor reconstructed based on the MPEG extension includes: if the target accessor description module includes the MPEG time-varying accessor, determining that the target accessor is the time-varying accessor reconstructed based on an MPEG extension; or if the target accessor description module does not include the MPEG time-varying accessor, determining that the target accessor is not the time-varying accessor reconstructed based on the MPEG extension.

Step g6: Determine, based on a value of a second buffer view index syntax element (bufferView) in the MPEG time-varying accessor (MPEG_accessor_timed) of the target accessor description module, a buffer view description module corresponding to a buffer view for caching a time-varying parameter of the target accessor.

For example, if a second buffer view index syntax element in an MPEG time-varying accessor of an accessor description module and its value are “bufferView” 3, it may be determined that a time-varying parameter of an accessor corresponding to the accessor description module is cached in a buffer view corresponding to a fourth buffer view description module in the buffer view list (“buffer Views”: [ ]).

Step g7: Determine, based on a time-varying syntax element (immutable) in the MPEG time-varying accessor (MPEG_accessor_timed) of the target accessor description module, whether a value of a syntax element in the target accessor changes over time.

In some embodiments, the determining, based on a time-varying syntax element (immutable) in the MPEG time-varying accessor of the target accessor description module, whether a value of a syntax element in the target accessor changes over time includes: if the time-varying syntax element in the MPEG time-varying accessor of the target accessor description module and its value are “immutable”: true or “immutable”: 1, determining that the value of the syntax element in the target accessor does not change over time; or if the time-varying syntax element in the MPEG time-varying accessor of the target accessor description module and its value are “immutable”: false or “immutable”: 0, determining that the value of the syntax element in the target accessor changes over time.

Step g8: Determine a name of the target accessor based on a value of an accessor name syntax element (name) in the target accessor description module.

In some embodiments, the method for parsing a scene description document further includes: obtaining a target buffer description module from a buffer list (“buffers”: [ ]) of the scene description document, and obtaining, based on the target buffer description module, description information of a target buffer corresponding to the target buffer description module.

The target buffer description module is any buffer description module obtained in the buffer list (“buffers”: [ ]) of the scene description document.

In some embodiments, the obtaining, based on the target buffer description module, description information of a target buffer corresponding to the target buffer description module includes at least one of following steps h1 to h7:

Step h1: Obtain a name of the target buffer based on a value of a buffer name syntax element (name) in the target buffer description module.

For example, if the buffer name syntax element in the target buffer description module and its value are “name”: “haptic_buffer”, it may be determined that the name of the target buffer is “name”: “haptic_buffer”.

Step h2: Obtain, based on a value of a first byte length syntax element (byteLength) in the target buffer description module, a capacity of the target buffer corresponding to the target buffer description module.

For example, if a first byte length syntax element in a buffer description module and its value are “byteLength”: 43972, it may be determined that a capacity of a buffer corresponding to the buffer description module is 43972 bytes.

Step h3: Determine, based on whether the target buffer description module includes an MPEG circular buffer (MPEG_buffer_circular), whether the target buffer is a circular buffer reconstructed based on the MPEG extension.

In some embodiments, the determining, based on whether the target buffer description module includes an MPEG circular buffer, whether the target buffer is a circular buffer reconstructed based on the MPEG extension includes: if the target buffer description module includes the MPEG circular buffer, determining that the target buffer is the circular buffer reconstructed based on the MPEG extension; or if the target buffer description module does not include the MPEG circular buffer, determining that the target buffer is not the circular buffer reconstructed based on the MPEG extension.

Step h4: Obtain a quantity of storage stages of the target buffer based on a value of a stage count syntax element (count) in the MPEG circular buffer of the target buffer description module.

For example, if a stage count syntax element in an MPEG circular buffer of a buffer description module and its value are “count”: 3, it may be determined that a buffer corresponding to the buffer description module includes three storage stages.

Step h5: Obtain, based on a value of a media index syntax element (media) in the MPEG circular buffer of the target buffer description module, an index value of a media description module corresponding to a media file to which source data of data cached in the target buffer belongs.

Step h6: Obtain, based on a value of a second track index syntax element (tracks) in the MPEG circular buffer of the target buffer description module, a track index value of the source data of the data cached in the target buffer.

Step h7: Obtain, based on a value of a URI syntax element (uri) in the target buffer description module, a URI of the source data of the data cached in the target buffer.

In some embodiments, the method for parsing a scene description document further includes: obtaining a target buffer view description module from the buffer view list (“buffer Views”: [ ]) of the scene description document, and obtaining, based on the target buffer view description module, description information of a target buffer view corresponding to the target buffer view description module.

The target buffer view description module is any buffer view description module in the buffer view list.

In some embodiments, the obtaining, based on the target buffer view description module, description information of a target buffer view corresponding to the target buffer view description module includes at least one of following steps j1 to j3:

Step j1: Obtain, based on a value of a second byte length syntax element (byteLength) in the target buffer view description module, a capacity of the target buffer view corresponding to the target buffer view description module.

For example, if a second byte length syntax element in a buffer view description module and its value are “byteLength”: 21936, it may be determined that a capacity of a buffer view corresponding to the buffer view description module is 21936 bytes.

Step j2: Obtain, based on a value of an offset syntax element (byteOffset) in the target buffer view description module, an offset of data cached in the target buffer view.

For example, if an offset syntax element in a buffer view description module and its value are “byteOffset”: 0, it may be determined that an offset of data cached in a buffer view corresponding to the buffer view description module is 0.

Step j3: Obtain a name of the target buffer view based on a value of a buffer view name syntax element (name) in the target buffer view description module.

In some embodiments, the method for parsing a scene description document further includes: determining a version number of the scene description document based on a version syntax element (version) in a digital asset description module (asset) in the scene description document and its value.

For example, a digital asset of the scene description document may be as follows:

| | |
|---|---|
| n+1 | “asset”: { |
| n+2 | “version”: “2.0” |
| n+3 | }, |

Therefore, it may be determined that the scene description document is compiled based on glTF2.0, and a version of the scene description document is a reference version of a scene description standard.

In some embodiments, the method for parsing a scene description document further includes: obtaining, based on a list of extensions used (extensionUsed) of the scene description document, an extension item used in the scene description document.

For example, the list of extensions used (extensionUsed) of the scene description document may be as follows:

| | |
|---|---|
| n+1 | “extensionsUsed”: [ |
| n+2 | “MPEG_media”, |
| n+3 | “MPEG_interactivity”, |
| n+4 | “MPEG_Haptic”, |
| n+5 | “MPEG_material_Haptic”, |
| n+6 | “MPEG_buffer_circular”, |
| n+7 | “MPEG_accessor_timed” |
| n+8 | ], |

Therefore, the following extension items used in the scene description document may be obtained: the MPEG media (MPEG_media), the MPEG interactivity (MPEG_interactivity), the MPEG haptic (MPEG_Haptic), the MPEG haptic material (MPEG_material_Haptic), the MPEG circular buffer (MPEG_buffer_circular), and the MPEG time-varying accessor (MPEG_accessor_timed).

In some embodiments, the method for parsing a scene description document further includes: determining, based on a scene declaration of the scene description document, a scene description module corresponding to the 3D-scene-to-be-rendered.

For example, if the scene declaration of the scene description document is “scene”: 0, it may be determined that the scene description n module corresponding to the 3D-scene-to-be-rendered is a first scene description module in the scene list (“scenes”: [ ]) of the scene description document.

In some embodiments, some embodiments of the present disclosure provide an apparatus, including:
a memory configured to store a computer program; and
a processor configured to call the computer program to enable the apparatus to implement the method for parsing a scene description document in any one of the aforesaid embodiments.

In some embodiments, some embodiments of the present disclosure provide a computer-readable storage medium. The computer-readable storage medium stores a computer program, and the computer program is executed by a computer device to implement the method in any one of the aforesaid embodiments.

In some embodiments, some embodiments of the present disclosure provide a computer program product. When the computer program product runs on a computer, the computer is enabled to implement the method in any one of the aforesaid embodiments.

Finally, it should be noted that the foregoing embodiments are used only to describe the technical solutions of the present disclosure, but are not intended to limit the present disclosure. Although the present disclosure has been described in detail with reference to the foregoing embodiments, those of ordinary skill in the art should understand that they may still modify the technical solutions described in the foregoing embodiments, or make equivalent substitutions on some or all technical features therein. The modifications or substitutions do not make the essence of the corresponding technical solutions deviate from the scope of the technical solutions in the embodiments of the present disclosure.

For the convenience of explanation, the above descriptions have been provided in combination with specific implementations. However, the above exemplary discussion is not intended to be exhaustive or to limit the implementations to the specific forms disclosed above. According to the above teachings, various modifications and variations may be obtained. The above implementations are selected and described to better explain the principles and practical applications, such that those skilled in the art may better use the implementations and implementations of various different variations considered in specific usage.

What is claimed is:

1. A method for parsing a scene description document implemented by a display engine, the method comprising:
determining an index value of a target haptic object description module;
obtaining the target haptic object description module from a moving picture experts group (MPEG) haptic description module in the scene description document according to the index value of the target haptic object description module; and
obtaining description information of a haptic media accessor according to the target haptic object description module, wherein the haptic media accessor is an accessor configured to access haptic rendering data of a haptic media file declared in an MPEG media description module.

2. The method according to claim 1, wherein said determining the index value of the target haptic object description module comprises:
obtaining a target haptic action node array from a haptic action node list of a target action description module of an MPEG interactivity description module in a scene description document of a three-dimensional (3D)-scene-to-be-rendered; and
determining, according to the target haptic action node array, an index value of a target haptic object description module corresponding to a haptic object associated with a target action node; and
the obtaining description information of a haptic media accessor according to the target haptic object description module comprises:
obtaining, according to the target haptic object description module, description information of a haptic media accessor associated with the target action node when a target haptic action is executed in the 3D-scene-to-be-rendered, wherein the target haptic action is a haptic action corresponding to the target action description module, and the haptic media accessor is an accessor configured to access haptic rendering data of a haptic media file declared in an MPEG media description module associated with the target action node when the target haptic action is executed.

3. The method according to claim 2, wherein said determining, according to the target haptic action node array, the index value of the target haptic object description module corresponding to the haptic object associated with the target action node comprises:
obtaining a value of a haptic object index syntax element in the target haptic action node array; and
determining the value of the haptic object index syntax element as the index value of the target haptic object description module.

4. The method according to claim 2, wherein said obtaining, according to the target haptic object description module, the description information of the haptic media accessor associated with the target action node when the target haptic action is executed in the 3D-scene-to-be-rendered comprises:
obtaining a value of an accessor index syntax element in the target haptic object description module;
obtaining an accessor description module corresponding to the haptic media accessor from an accessor list of the scene description document according to the value of the accessor index syntax element; and
obtaining the description information of the haptic media accessor according to the accessor description module corresponding to the haptic media accessor.

5. The method according to claim 2, further comprising:
obtaining a value of an action type syntax element in the target action description module; and
obtaining a type of a target action according to the value of the action type syntax element.

6. The method according to claim 2, further comprising:
obtaining a target behavior array from a behavior list of the MPEG interactivity description module, wherein the target behavior array is any behavior array in the behavior list; and
obtaining, according to the target behavior array, description information of a target behavior corresponding to the target behavior array, wherein,
said obtaining, according to the target behavior array, the description information of the target behavior corresponding to the target behavior array comprises at least one of following operations:
determining, according to a value of a trigger index syntax element in the target behavior array, an index value of a trigger description module corresponding to a trigger of the target behavior; and
determining, according to a value of an action index syntax element in the target behavior array, an index value of an action description module corresponding to an action of the target behavior.

7. The method according to claim 2, further comprising:
obtaining a target trigger description module from a trigger list of the MPEG interactivity description module; and
obtaining, according to the target trigger description module, description information of a target trigger corresponding to the target trigger description module, wherein, the target trigger description module is any trigger description module in the trigger list; and
said obtaining, according to the target trigger description module, the description information of the target trigger corresponding to the target trigger description module comprises:
obtaining a type of the target trigger according to a value of a trigger type syntax element in the target trigger description module.

8. The method according to claim 1, further comprising:
obtaining a target media description module corresponding to the haptic media file from a media list of the MPEG media description module in the scene description document; and
obtaining description information of the haptic media file according to the target media description module, wherein,
the obtaining description information of the haptic media file according to the target media description module comprises at least one of following operations:
obtaining a name of the haptic media file according to a value of a media name syntax element in the target media description module;
determining, according to a value of an autoplay syntax element in the target media description module, whether the haptic media file needs to be automatically played;
determining, according to a value of a loop syntax element in the target media description module, whether the haptic media file needs to be cyclically played; and
obtaining description information of each alternative version of the haptic media file according to each alternative version description module in an alternative version list of the target media description module.

9. The method according to claim 8, wherein said obtaining the description information of each alternative version of the haptic media file according to each alternative version description module in the alternative version list in the target media description module comprises at least one of following operations:
obtaining, according to a value of a media type syntax element in a target alternative version description module, data contained in a target alternative version corresponding to the target alternative version description module, wherein the target alternative version description module is any alternative version description module in the alternative version list;
obtaining a uniform resource identifier (URI) of the target alternative version according to a value of a URI syntax element in the target alternative version description module;
obtaining an index value of each bitstream track of the target alternative version according to a value of a first track index syntax element in a track array of the target alternative version description module; and
obtaining a decoding parameter of a bitstream of the target alternative version according to a value of a codec parameter syntax element in the track array of the target alternative version description module and a provision in a standard for carriage of haptics data.

10. The method according to claim 9, wherein the obtaining, according to a value of a media type syntax element in a target alternative version description module, data contained in a target alternative version corresponding to the target alternative version description module comprises:
in accordance with a determination that the value of the media type syntax element is a first preset value, determining that the target alternative version comprises haptic data and audio video and/or video data; or
in accordance with a determination that the value of the media type syntax element is a second preset value, determining that the target alternative version comprises haptic data.

11. The method according to claim 1, further comprising:
obtaining a target scene description module corresponding to a 3D-scene-to-be-rendered from a scene list of the scene description document; and
obtaining description information of the 3D-scene-to-be-rendered according to the target scene description module, wherein,
said obtaining the description information of the 3D-scene-to-be-rendered according to the target scene description module comprises:
obtaining, according to an index value declared in a node index list of the target scene description module, an index value of a node description module corresponding to each node in the 3D-scene-to-be-rendered.

12. The method according to claim 1, further comprising:
obtaining a target node description module from a node list of the scene description document; and
obtaining, according to the target node description module, description information of a target node corresponding to the target node description module, wherein,
the target node description module is any node description module in the node list; and said obtaining, according to the target node description module, the description information of the target node corresponding to the target node description module comprises at least one of following operations:
obtaining a name of the target node according to a value of a node name syntax element in the target node description module;
obtaining, according to an index value declared in a child node index list of the target node description module, an index value of a node description module corresponding to each child node mounted to the target node;
obtaining, according to an index value declared in a mesh index syntax element in the target node description module, an index value of a mesh description module corresponding to each 3D mesh mounted to the target node; and
obtaining a spatial position offset of the target node relative to a parent node of the target node according to a value of a position offset syntax element in the target node description module.

13. The method according to claim 1, further comprising:
obtaining a target mesh description module from a mesh list of the scene description document; and
obtaining, according to the target mesh description module, description information of a target 3D mesh corresponding to the target mesh description module, wherein,
the target mesh description module is any mesh description module in the mesh list; and said obtaining, according to the target mesh description module, the description information of the target 3D mesh corresponding to the target mesh description module comprises at least one of following operations:
obtaining a name of the target 3D mesh according to a value of a mesh name syntax element in the target mesh description module;
obtaining, according to a value of a texture coordinate syntax element in an attribute of a primitive of the target mesh description module, an index value of an accessor description module corresponding to an accessor for accessing a texture coordinate of the target 3D mesh;
obtaining a topology type of the target 3D mesh according to a value of a mode syntax element in the primitive of the target mesh description module; and
obtaining, according to a value of a haptic material array index syntax element in an MPEG haptic material description module in the primitive of the target mesh description module, description information of a haptic material attribute carried by the target 3D mesh.

14. The method according to claim 13, wherein said obtaining, according to the value of the haptic material array index syntax element in the MPEG haptic material description module in the primitive of the target mesh description module, the description information of the haptic material attribute associated with the target 3D mesh comprises:
obtaining a haptic material array associated with the target 3D mesh from a haptic material list of the scene description document according to the value of the haptic material array index syntax element;
obtaining a haptic material attribute description module corresponding to each haptic material attribute carried by the target 3D mesh from the haptic material array associated with the target 3D mesh; and
obtaining, according to the haptic material attribute description module corresponding to each haptic material attribute carried by the target 3D mesh, the description information of the haptic material attribute carried by the target 3D mesh; wherein,
said obtaining, according to the haptic material attribute description module corresponding to each haptic material attribute carried by the target 3D mesh, the description information of the haptic material attribute carried by the target 3D mesh comprises at least one of following operations:
obtaining, according to a value of a texture index syntax element in a texture array of a target haptic material attribute description module, texture description information of a texture associated with a target haptic material corresponding to the target haptic material attribute description module, wherein the target haptic material attribute description module is any haptic material attribute description module in the haptic material array associated with the target 3D mesh;
obtaining, according to a value of a texture coordinate index syntax element in the texture array of the target haptic material attribute description module, an index value of a texture coordinate syntax element associated with the target haptic material; and
obtaining a type of a target haptic material attribute according to a value of a haptic material type syntax element in the texture array of the target haptic material attribute description module.

15. The method according to claim 14, wherein said obtaining, according to the value of the texture index syntax element in the texture array of the target haptic material attribute description module, the texture description information of the texture associated with the target haptic material corresponding to the target haptic material attribute description module comprises:
obtaining a target texture description module from a texture list of the scene description document according to the value of the texture index syntax element; and
obtaining, according to the target texture description module, the texture description information of the texture associated with the target haptic material, wherein,
said obtaining, according to the target texture description module, the texture description information of the texture associated with the target haptic material comprises at least one of following operations:
obtaining description information of a sampler of the target haptic material according to a value of a sampler index syntax element in the target texture description module; and
obtaining description information of a texture resource corresponding to the texture resource of the target haptic material according to a value of a texture resource index syntax element in the target texture description module.

16. The method according to claim 15, wherein the obtaining description information of a sampler of the target haptic material according to a value of a sampler index syntax element in the target texture description module comprises:
obtaining a sampler description module corresponding to the sampler of the target haptic material from a sampler list of the scene description document according to the value of the sampler index syntax element in the target texture description module; and
obtaining the description information of the sampler of the target haptic material according to the sampler description module corresponding to the sampler of the target haptic material.

17. The method according to claim 15, wherein said obtaining the description information of the texture resource of the target haptic material according to the value of the texture resource index syntax element in the target texture description module comprises:
obtaining a texture resource description module corresponding to the texture resource of the target haptic material from a texture resource list of the scene description document according to the value of the texture resource index syntax element in the target texture description module; and
obtaining the description information of the texture resource of the target haptic material according to the texture resource description module corresponding to the texture resource of the target haptic material.

18. The method according to claim 1, further comprising:
obtaining a target accessor description module from an accessor list of the scene description document; and
obtaining, according to the target accessor description module, description information of a target accessor corresponding to the target accessor description module, wherein, the target accessor description module is any accessor description module in the accessor list;
and said obtaining, according to the target accessor description module, the description information of the target accessor corresponding to the target accessor description module comprises at least one of following operations:
obtaining, according to a value of a data type syntax element in the target accessor description module, a type of data accessed by the target accessor;
determining a type of the target accessor according to a value of an accessor type syntax element in the target accessor description module;
determining, according to a value of a data count syntax element in the target accessor description module, a count of the data accessed by the target accessor;
determining, according to a value of a target buffer view index syntax element in the target accessor description module, an index value of a buffer view description module corresponding to a buffer view for caching the data accessed by the target accessor;
determining, in accordance with a determination regarding whether the target accessor description module comprises an MPEG time-varying accessor, whether the target accessor is a time-varying accessor based on an MPEG extension;
determining, according to a value of a second buffer view index syntax element in the MPEG time-varying accessor of the target accessor description module, an index value of a buffer view description module corresponding to a buffer view for caching a time-varying parameter of the target accessor;
determining, according to a value of a time-varying syntax element in the MPEG time-varying accessor of the target accessor description module, whether a parameter of the target accessor changes over time; and
determining a name of the target accessor according to a value of an accessor name syntax element in the target accessor description module.

19. The method according to claim 1, further comprising:
obtaining a target buffer description module from a buffer list of the scene description document; and
obtaining, according to the target buffer description module, description information of a target buffer corresponding to the target buffer description module, wherein, the target buffer description module is any buffer description module in the buffer list; and
said obtaining, according to the target buffer description module, the description information of the target buffer corresponding to the target buffer description module comprises at least one of following operations:
obtaining a name of the target buffer according to a value of a buffer name syntax element in the target buffer description module;
obtaining a capacity of the target buffer according to a value of a first byte length syntax element in the target buffer description module;
determining, in accordance with a determination regarding whether the target buffer description module comprises an MPEG circular buffer, whether the target buffer is a circular buffer based on an MPEG extension;
obtaining a quantity of storage stages of the target buffer according to a value of a stage count syntax element in the MPEG circular buffer of the target buffer description module;
obtaining, according to a value of a media index syntax element in the MPEG circular buffer of the target buffer description module, an index value of a media description module corresponding to a media file to which source data of data cached in the target buffer belongs;
obtaining, according to a value of a second track index syntax element in the MPEG circular buffer of the target buffer description module, a track index value of the source data of the data cached in the target buffer; and
obtaining, according to a value of a URI syntax element in the target buffer description module, a URI of the source data of the data cached in the target buffer.

20. The method according to claim 1, further comprising:
obtaining a target buffer view description module from a buffer view list of the scene description document; and
obtaining, according to the target buffer view description module, description information of a target buffer view corresponding to the target buffer view description module, wherein,
the target buffer view description module is any buffer view description module in the buffer view list; and said obtaining, according to the target buffer view description module, the description information of the target buffer view corresponding to the target buffer view description module comprises at least one of following operations:
obtaining, according to a value of a second byte length syntax element in the target buffer view description module, a capacity of the target buffer view corresponding to the target buffer view description module;
obtaining, according to a value of an offset syntax element in the target buffer view description module, an offset of data cached in the target buffer view; and
obtaining a name of the target buffer view according to a value of a buffer view name syntax element in the target buffer view description module.
